(19) United States
(12) Patent Application Publication
(10) Pub. No.: US 2010/0298163 A1
(43) Pub. Date: Nov. 25, 2010

(54) MICROFLUIDIC MICROARRAY SYSTEM AND METHOD FOR THE MULTIPLEXED ANALYSIS OF BIOMOLECULES

(75) Inventors: David Juncker, Barcelona (ES); Mateu Pla, Barcelona (ES)

Correspondence Address: CANTOR COLBURN LLP, 20 Church Street, 22nd Floor, Hartford, CT, 06103, US

(73) Assignee: THE ROYAL INSTITUTION FOR THE ADVANCEMENT OF LEARNING/MCGILL UNIVERSITY, Montreal, QC (CA)

(21) Appl. No.: 12/811,316

(22) PCT Filed: Jan. 5, 2009
(86) PCT No.: PCT/CA09/00008

§ 371 Date: Aug. 5, 2010

Related U.S. Application Data
(63) Continuation-in-part of application No. 61/019,128, filed on Jan. 4, 2008.

(51) Int. Cl. C40B 30/04; C40B 60/00; C40B 50/14

(52) U.S. Cl. 506/9; 506/33; 506/30

(57) ABSTRACT

A microfluidic system for fluid transfer to a microarray includes a liquid transfer needle having a fluid conduit therein within which is defined a withholding pressure P1, and a microcompartment defined within the microarray, the microcompartment being configured to generate a capillary pressure P2 therein. The capillary pressure P2 is less than the withholding pressure P1, such that a defined amount of liquid is transferred from the liquid transfer needle into the microcompartment when the liquid transfer needle and the microcompartment are disposed in fluid flow communication. A method of delivering multiple solutions to a plurality of microcompartments in an microarray while avoiding cross-contamination between the solutions is also provided.

### CROSS-REFERENCE TO RELATED APPLICATIONS

The present application claims priority on U.S. provisional patent application No. 60/019,128 filed Jan. 4, 2008, the entire contents of which is incorporated herein by reference.

### TECHNICAL FIELD

The present invention relates generally to the field of bio-analysis and microfluidics. More specifically, the invention relates to a microfluidic system and method for the analysis of biomolecules such as proteins, DNA, RNA, etc. in bodily fluids and tissues.

### BACKGROUND OF THE INVENTION

Rapid and specific detection of biological cells and biomolecules, such as red blood cells, white blood cells, platelets, proteins, DNAs, and RNAs, have become more and more important to biological assays crucial to fields such as genomics, proteomics, diagnoses, and pathological studies. For example, the rapid and accurate detection of specific antigens and viruses is critical for combating pandemic diseases such as AIDS, flu, and other infectious diseases. Also, due to faster and more specific methods of separating and detecting cells and biomolecules, the molecular-level origins of diseases are being elucidated at a rapid pace, potentially ushering in a new era of personalized medicine in which a specific course of therapy is developed for each patient. To fully exploit this expanding knowledge of disease phenotype, new methods for detecting multiple biomolecules (e.g. viruses, DNAs and proteins) simultaneously are required. Such multiplex biomolecule detection methods must be rapid, sensitive, highly parallel, and ideally capable of diagnosing cellular phenotype.

One specific type of biological assay increasingly used for medical diagnostics, as well as in food and environmental analysis, is the immunoassay. An immunoassay is a biochemical test that measures the level of a substance in a biological liquid, such as serum or urine, using the reaction of an antibody and its antigen. The assay takes advantage of the specific binding of an antibody to its antigen. Monoclonal antibodies are often used as they only usually bind to one site of a particular molecule, and therefore provide a more specific and accurate test, which is less easily confused by the presence of other molecules. The antibodies picked must have a high affinity for the antigen (if there is antigen in the sample, a very high proportion of it must bind to the antibody so that even when only a few antigens are present, they can be detected). In an immunoassay, both the presence of antigen or the patient's own antibodies (which in some cases are indicative of a disease) can be measured. For instance, when detecting infection the presence of antibody against the pathogen is measured. For measuring hormones such as insulin, the insulin acts as the antigen. Conventionally, for numerical results, the response of the fluid being measured is compared to standards of a known concentration. This is usually done though the plotting of a standard curve on a graph, the position of the curve at response of the unknown is then examined, and so the quantity of the unknown found. The detection of the quantity of antibody or antigen present can be achieved by either the antigen or antibody.

An increasing amount of biological assays, such as immunoassays and gene expression analysis, are carried out using microarrays, such as DNA microarrays, protein microarrays or antibody microarrays, for example. A microarray is a collection of microscopic spots such as DNA, proteins or antibodies, attached to a substrate surface, such as a glass, plastic or silicon, and which thereby form a “microscopic” array. Such microarrays can be used to measure the expression levels of large numbers of genes or proteins simultaneously. The biomolecules, such as DNAs, proteins or antibodies, on a microarray chip are typically detected through optical readout of fluorescent labels attached to a target molecule that is specifically attached or hybridized to a probe molecule. The labels used may consist of an enzyme, radioisotopes, or a fluorophore.

A large number of assays use a sandwich assay format for performing the assay. In this format, a capture probe molecule is immobilized on a surface. In the subsequent steps, a sample solution containing target molecules, also called analytes is applied to the surface. The target or analyte binds in a concentration dependent manner to the capture probe molecules immobilized on the surface. In a subsequent step, a solution containing detection probe molecules is applied to the surface, and the detection probe molecules can then bind to the analyte molecule. The analyte is thus “sandwiched” between the capture probe and detection probe molecules. In some assays, a secondary probe molecule is also applied to the assay, which can bind the detection probe molecule. The secondary probe can be conjugated to a fluorophore, in which case the binding result can be detected using a fluorescence scanner or a fluorescence microscope. In some cases, the secondary probe is conjugated to radioactive element, in which case the radioactivity is detected to read out the assay result. In some cases, the secondary probe is conjugated to an enzyme, in which case a solution containing a substrate has to be added to the surface, and the conversion of the substrate by the enzyme can be detected. The intensity of the signal detected is in all cases proportional to the concentration of the analyte in the sample solution.

Another type of cell and biomolecule separation and detection method uses microfluidic devices to conduct high throughput separation and analysis based on accurate flow controls through the microfluidic channels. By designing patterned fluidic channels, or channels with specific dimensions in the micro or sub-micro scales, often on a small chip, one is able to carry out multiple assays simultaneously. The cells and biomolecules in microfluidic assays are also typically detected by optical readout of fluorescent labels attached to a target cell or molecule that is specifically attached or hybridized to a probe molecule.

However, for protein analysis it remains very challenging to develop multiplexed assays. A number of recent attempts have been made to develop improved multiplexed antibody microarrays for use in quantitative proteomics, and various researchers have begun to examine the particular issues involved. Some of the general considerations in assembling multiplexed immunoassays have been found to include: requirements for elimination of assay cross-reactivity; configuration of multianalyte sensitivities; achievement of dynamic ranges appropriate for biological relevance when performed in diverse matrices and biological states; and optimization of reagent manufacturing and chip production to achieve acceptable reproducibility. In contrast to traditional monoplex enzyme-linked immunoassays, generally agreed specifications and standards for antibody microarrays have not yet been formulated.

The challenge of multiplexed immunoassay is further compounded when using complex biological samples, such as blood and its plasma and serum derivatives or other bodily fluids. The dynamic range of concentration of protein in blood has been found to span 11 orders of magnitude. Thus, when identifying low abundance proteins in blood, it has to be made against a background of proteins 11 orders of magnitude more numerous. As an analogy, if we were to identify a single person among the entire world population it would correspond to less than 10 orders of magnitude, as the world population is still less than 10 billion people.

It is also well known that developing non-interacting sets of sandwich assays becomes exponentially more difficult as the size of the array increases. Optimization of multiplexed assays is a challenging enterprise that has been presented by Perlee et al. (Development and standardization of multiplexed antibody microarrays for use in quantitative proteomics, Proteome Science 2, 1-22 (2004)). One strategy that is used in practice and discussed by Perlee et al is to partition arrays featuring more than approximately 25 targets, e.g. by making two 25-assay arrays instead of one 50-assay array. Yet even in the case of 25 antibodies in such a 25-assay array, optimization remains a major effort, as illustrated in the publication by Gonzalez, R. M., et al. (Development and Validation of Sandwich ELISA Microarrays with Minimal Assay Interference, Journal of Proteome Research, 2008. 7(6): p. 2406-2414). Gonzalez et al. systematically test the cross-reactivity between analyte and capture antibodies and between detection antibodies and analyte. To do so they prepared 24 mixtures of detection antibodies, where each mixture lacked the detection antibody corresponding to the cross-reactivity that is being investigated. In addition, they prepared 25 solutions with each of the detection antibodies alone. This represents a significant amount of work, yet it only uncovers cross-reactivities within about one to two orders of magnitude, because 10% of the maximal concentration were used and the assays typically covered only 2-3 orders of magnitude; and yet because each sample from each patient is different, and may contain a protein with a mutation that leads to cross-reactivity, it is impossible to test beforehand all cross-reactivities. Moreover, when a new analyte is added to the chip, a full optimization protocol for cross-reactivity between this analyte and any other analyte must be carried out.

Partitioning in order to circumvent the issue of having a large number of detection antibodies is also explored by Forrester, S. et al. (Low-volume, high-throughput sandwich immunoassays for profiling plasma proteins in mice: Identification of early-stage systemic inflammation in a mouse model of intestinal cancer, Molecular Oncology 1, 216-225 (2007)). In this example, the partitions are formed by printing wax borders onto microscope slides, and each partition contains a small number of spots. In the examples proposed, each partition contains the same spots and different samples are then applied to each partition, which allows reducing sample consumption. As a measure to avoid cross-reactivity of the sandwich assay, only a single detection antibody is applied to one slide. This approach is somewhat reminiscent of reverse phase microarrays, where different samples are spotted as microarrays onto a slide, and where a single antibody is applied to a single slide, but covering many samples. However in the method proposed by Forrester, S. et al., 192 partitions with 12 spots are provided, which limits the number of analyses that can be made to 12 per slide. Alternatively, their slides have 48 arrays with 144 spots, which then requires the application of the same sample 144 times to 144 different slides. Since 6 microliters are required with each application, this approach necessitates 865 microliters of sample for analyzing 144 analytes, which constitutes an excessively large amount for many applications. Whereas their approach solves the issue of cross-reactivity, it comes at the expense of repetition of experiments and of large sample consumption. There would be an advantage if the experiments could be performed on all analytes at once, so that only a single sample incubation would be required and only one slide used per sample to obtain the concentration of multiple analytes.

In proteomics, it is not only important to measure protein concentration, but also to measure additional characteristics of the protein, such as protein isoforms including ones due to genetic mutation or post-translational modifications such as phosphorylation or glycosylation, stages of protein maturation, and its activity. However, it is currently not generally feasible using current microarray methods to measure the concentration while simultaneously probing protein isoforms, protein maturation, post-translational modifications and activity on the same microarray. Recent attempts have been made to use antibody microarrays to capture different glycoproteins and then test their glycosylation patterns by exposing the entire chip to a single Lectin. To test for different glycosylation patterns, multiple chips were used and exposed to multiple lectins. Although not yet known in the art, it would be more advantageous to be able to expose multiple proteins to multiple lectins or other glycosylation-specific probes on a single chip.

In proteomics, it is also very important to measure associating and binding between different proteins which can form complexes. The analysis of protein complexes is commonly done using mass spectrometry methods and so-called tandem affinity purification. Measuring the association of proteins can help unravel their function, using strategies based on “guilt by association”, meaning that if a protein binds to another one, they are likely to be involved in the same signaling pathway. Mass spectrometry however typically requires close to milliliter quantities, is a serial method, necessitates important capital investment, heavily relies on bioinformatics and databases making the interpretation difficult and prone to errors. It would be desirable to have a more straightforward method to measure protein complexes using minute amounts of samples and using multiplexed approaches such as microarrays.

There remains, therefore, a need for a system and method which can be used to multiplex a large number of assays on a single slide, while overcoming at least some of the drawbacks described above, including the issues of cross-reactivity. At macroscopic scales, where miniaturization and microfluidic effects do not appear, such as in ELISA plates for example, only a single analyte is measured in each well. However, in such ELISA plates, only a single analyte is typically measured on an entire plate, and there is no multiplexing.

There would therefore also be significant advantage in having the conditions of an ELISA assay, but with multiplexing. Such a scheme would however entail complicated liquid handling, because multiple different solutions would need to be delivered to different wells, which is impractical with known systems. In addition, the requirement for multiplexing entail miniaturizations, because only a limited amount of sample is available, and hence the different reactions have to be performed using little sample. However, multiplexed liquid handling, at a microscale, of large numbers of samples without incurring significant dead volumes, is to date a largely unsolved problem.

One known approach employed for small scale liquid handling is to use pin spotters. Pin spotters deposit minute amounts of sample on a flat microarray slide. More advanced forms of pin spotters feature reservoirs that allow spotting multiple times the same solution on a large number of different slides. However, pin spotters typically need to contact the surface, which can compromise the quality of the pattern that has been spotted. The quantity of liquid deposited is typically minute, and is susceptible to evaporation. Therefore, many additives such as glycerol are added to the solutions to prevent the complete evaporation of the droplet.

Known miniaturized liquid handling technologies include bio-ink-jets or drop-on-demand spotters. Bio-ink-jets are non-contact devices that can deliver droplets a few tens or hundreds of micrometer in diameter, with volumes of a few picoliters to nanoliters, to predefined locations. However, it is well known that bio-ink-jet printers suffer from shortcomings for biological applications. First, they require a large volume to fill their reservoir and generally suffer from dead volumes of close to 1 microliter or more. Second, they are prone to malfunction, and in commercial instruments such as the GeSIM Nanoplotter™, a special software was installed to repair missing spots on microarrays in case of malfunction of a nozzle. However, this approach is not 100% successful, and it is time consuming. Third, the spotting parameters have to be readjusted whenever a new solution with a different viscosity is loaded. Simply exchanging the biomolecules in a solution may require readjusting the parameters. Fourth, electrostatic charges between the nozzles and the substrate can lead to non-straight spotting and misalignment of the spotted drops on the microarray. Whereas in conventional applications precise alignment is not critical, in a case where multiple spots of different solutions need to be spotted on the same location it becomes a problem. Finally, commonly used bio-ink-jets use nozzles in the shape of needles or capillaries, which are fragile, easily break, and which are expensive.

In part because of the above mentioned reasons, the parallelism achieved with bio-ink-jets is still typically limited to 8 or 16 nozzles. Most recently, a new technology with 32 nozzles has been proposed by Arrayjet™, but it is unclear how robust this technology is in practice. The monolithic integration of the head also implies that if one nozzle is clogged or otherwise malfunctioning, the entire head may need replacement. Finally, all inkjet type systems need complex electronic equipment to control droplet delivery.

Therefore, there remains a need for a liquid handling system that can deliver minute amounts of samples to an area reliably and without contacting the substrate surface where the reaction takes place, and without wasting large amounts of liquid as dead volume. There is further the need for a technology that can be easily scaled, so that many different solutions may be delivered in parallel to a large number of spots for multiplexing a large number of assays.

### SUMMARY OF THE INVENTION

In accordance with an embodiment of the present invention, there is provided a device that can complete multiplex analysis of biomolecules with limited sample volume.

In another embodiment, there is provided a pin that can hold a small amount of liquid and a miniaturized compartment called a microcompartment so that upon contact between the pin and the microcompartment, the microcompartment is filled with the liquid. The liquid may be retained by capillary effects in the pin, and the capillary effects of the microcompartment may affect the transfer of liquid from the pin to the microcompartment. In another embodiment, the liquid is retained in a capillary by capillary pressure. Yet in another embodiment, the liquid is retained in a capillary by controlling the pressure inside the capillary using a pressure source and a pressure controller.

In accordance with another embodiment, a method for making a microcompartment on a flat substrate surface is provided. The microcompartment may be fabricated such as to control precisely the capillary pressure it will generate by adjusting its geometry and the chemical composition of the surfaces in and around the microcompartment.

In accordance with yet another embodiment there is provided a method for performing multiplex detection of molecules delivered into the compartments, sample solutions and solutions containing detection biomolecules, in order to detect antibodies.

In accordance with an embodiment, a configuration of microcompartments into arrays partitioned within macrocompartments to correspond to a configuration of pins matching the microcompartments and macrocompartments is provided, as is a method of delivering liquids to the microcompartments.

Additionally, there is also provided, a method for quantifying at least one analyte and for measuring at least one characteristic of said analyte, including differentiating between protein isoforms including ones due to genetic mutation or post-translational modifications such as phosphorylation or glycosylation, stages of protein maturation, and activity of said analyte using multiplexed microarrays having a sandwich format and defining a plurality of microcompartments, the method comprising: delivering at least a first solution with a capture probe to each of the microcompartments individually; delivering at least a second solution with a cognate detection probe to at least one of said microcompartments individually; and delivering at least one third solution containing a detection probe specific for a characteristic of the second analyte, including differentiating between protein isoforms including ones due to genetic mutation or post-translational modifications such as phosphorylation or glycosylation, stages of protein maturation, and protein activity.

There is further still provided a method for quantifying at least one analyte and for measuring at least one post-translational modification or activity of said at least one analyte using multiplexed microarrays having a sandwich format and defining a plurality of microcompartments, the method comprising: delivering at least a first solution with a capture probe to each of the microcompartments individually; delivering at least a second solution with a cognate detection probe to at least one of said microcompartments individually; and delivering at least one third solution containing a detection probe specific for a characteristic of the second analyte, including differentiating between protein isoforms including ones due to genetic mutation or post-translational modifications such as phosphorylation or glycosylation, stages of protein maturation, and protein activity; whereas said second analyte can form a complex with the primary analyte; to at least one of said microcompartments individually.

In accordance with an aspect of the present invention, there is provided a microfluidic system for fluid transfer to a microarray comprising: at least one liquid transfer needle having a fluid conduit therein, a withholding pressure P1 being defined within the fluid conduit; at least one microcompartment defined within the microarray, the microcompartment being configured to generate a capillary pressure P2 therein; and wherein the capillary pressure P2 is less than the withholding pressure P1, such that a defined amount of liquid is transferred from the liquid transfer needle into the microcompartment when the liquid transfer needle and the microcompartment are disposed in fluid flow communication.

In accordance with another aspect of the present invention, there is provided a method of forming microfluidic microcompartments in a microarray comprising reversibly sealing a thin sheet having a plurality of openings therein onto a solid support substrate using an adhesive layer disposed between the thin sheet and the solid support substrate, the adhesive layer including rings which circumscribe each of the openings in the thin sheet to define the microcompartments therewithin.

In accordance with another aspect of the present invention, there is provided a method of forming microfluidic microcompartments in a microarray comprising: providing a solid support; coating at least part of the solid support with a photosensitive elastomer layer; and forming the photosensitive elastomer layer such that the microcompartments are defined between the solid support and the photosensitive elastomer layer.

There is also provided, in accordance with another aspect of the present invention, a method for aligning components of a microfluidic system used for the preparation of microarrays for use in the multiplexed analysis of biomolecules, the method comprising: aligning an array of fluid transfer pins with a microfluidic mask sealed against a glass slide, by first aligning the mask to the glass slide, and then aligning the glass slide on a deck of a spotter which has been aligned relative to a spotting head having said array of fluid transfer pins, the spotting head being aligned relative to XY displacement axes of the spotter.

There is further provided, in accordance with yet another aspect of the present invention, a method for aligning an array of fluid transfer pins with a microarray of a microfluidic system for use in the multiplexed analysis of biomolecules, the microarray having a microfluidic mask sealed against a slide, the method comprising: aligning a spotting deck of the microfluidic system relative to a spotting head having the array of fluid transfer pins, the spotting head being aligned relative to XY displacement axes of the microfluidic system; aligning the slide relative to said spotting deck and fixing the slide thereto; and aligning the microfluidic mask relative to alignment marks on the spotting deck, and sealing the microfluidic mask to the slide.

In accordance with another aspect of the present invention, there is provided a method of delivering multiple solutions to a plurality of microcompartments in an microarray while avoiding cross-contamination between the solutions, the method comprising: contacting a first portion of an edge of the microcompartments with a first liquid solution; rinsing away the first liquid solution; and contacting a second portion of the edge of the microcompartments with a second liquid solution, the first and second portions of the edge of the microcompartments being different.

In accordance with another aspect of the present invention, there is provided a method for delivering multiple solutions in parallel to an array of microcompartments, wherein a subset of the microcompartments are partitioned within macrocompartments, the method comprising: providing at least two fluid delivery pins per macrocompartment; arranging said pins within a spotting head in a configuration corresponding to that of said compartments; and spotting with at least two pins per macrocompartment to transfer multiple fluid solutions into different microcompartments of said macrocompartments.

In accordance with another aspect of the present invention, there is provided a method for multiplexing microarrays having a sandwich format and defining a plurality of microcompartments therein, the method comprising: individually delivering at least a first fluid solution containing a capture probe to each of the microcompartments; and individually delivering at least a second fluid solution to said each of the microcompartments using a cognate detection probe contained in said second fluid solution.

In accordance with another aspect of the present invention, there is provided a method for measuring at least one characteristic of a protein using multiplexed microarrays having a sandwich format and defining a plurality of microcompartments, the method comprising: delivering at least a first solution with a capture probe molecule to each of the microcompartments individually; collectively rinsing the microcompartments; and delivering to at least one of said microcompartments at least a second solution with a cognate detection probe molecule specific for the characteristic of the protein. The characteristic measured may include measuring, for example, differentiating between protein isoforms including ones due to genetic mutation or post-translational modifications such as phosphorylation or glycosylation, stages of protein maturation, and protein activity.

In accordance with another aspect of the present invention, there is provided a method for quantifying at least one analyte and for measuring at least one characteristic of the analyte using multiplexed microarrays having a sandwich format and defining a plurality of microcompartments, the method comprising: delivering at least a first solution with a capture probe to each of the microcompartments individually; delivering at least a second solution with a cognate detection probe to at least one of said microcompartments individually; and delivering at least a third solution containing a cognate detection probe specific for said at least one characteristic of the analyte to at least one of said microcompartments individually. The measured characteristic of the analyte may include, for example, differentiating between protein isoforms including ones due to genetic mutation or post-translational modifications such as phosphorylation or glycosylation, stages of protein maturation, and activity of said analyte.

In accordance with another aspect of the present invention, there is provided a method for delivering multiple analytes to a microarray for use in the multiplexed analysis of biomolecules, the microarray having a plurality of microcompartments therein, the method comprising: partitioning the microarray into a number of macrocompartments, each macrocompartment having a plurality of said microcompartments therein; and delivering multiple sample solutions, in parallel, to the microcompartments within each of said macrocompartments using at least one fluid delivery pin per macrocompartment.

### BRIEF DESCRIPTION OF THE DRAWINGS

These and other features will become more apparent from the following description in which reference is made to the appended drawings wherein:

FIGS. 1a-1c are schematic side elevation views of the liquid transfer from a reservoir needle to a microcompartment in accordance with an embodiment of the present invention;

FIG. 1d is a schematic perspective view of alternate fluid transfer pins in accordance with another embodiment;

FIGS. 1e-1f show top cross-sectional views of different configurations of pins and the simultaneous filling of microcompartment wells with pin arrays made of up of the different pin configurations;

FIG. 1g is a schematic side cross-sectional view of the liquid transfer between a pin and a microcompartment well;

FIG. 2a is a schematic top plan view of a mask with microcompartments in accordance with an embodiment of the present invention;

FIG. 2b is a schematic cross-sectional view taken through line 2b-2b of FIG. 2a;

FIG. 2c is a perspective view of a slide having a microfluidic mask in accordance with an embodiment of the present invention;

FIG. 3a is a schematic top plan view of a mask with microcompartments in accordance with an embodiment of the present invention;

FIG. 3b is a bottom plan view of the mask of FIG. 3a;

FIG. 3c is a cross-sectional view taken though line 3c-3c of FIG. 3a;

FIG. 4a is a bottom view of a first embodiment of elastomeric rings patterned on a microfluidic mask substrate to form microcompartments;

FIG. 4b is a bottom view of another embodiment of elastomeric rings patterned on a microfluidic mask to form microcompartments;

FIG. 4c is a bottom view of liquid confined within the microfluidic microcompartments of FIG. 4b;

FIGS. 5a-5c are schematic cross-sectional views of different embodiments of microcompartments;

FIGS. 6a-6f show the alignment system used for accurately aligning the microcompartment masks with the fluid plotter for spotting into the microcompartments;

FIG. 7a shows the process flow for a sandwich assay carried out using microcompartments;

FIG. 7b is a graphical schematic of the antibody colocalization microarray protocol of the process of FIG. 7a;

FIG. 7c shows trapped air bubbles in the microfluidic microcompartments of the masks, and the removal thereof;

FIG. 8 shows a series of microcompartments with capture probe molecules, analytes, and different detection probes;

FIG. 9 shows a series of microcompartments with identical capture probe molecules, analytes, and with different detection probes specific for proteins that can form complexes with the analyte immobilized to the capture probe;

FIG. 10 shows the result of two antibody colocalization assays carried out in two microcompartments, and two compartments with negative controls;

FIGS. 11a-11c show top plan views of microcompartments partitioned into macrocompartments with different magnification scales;

FIG. 12a-12b respectively show 32 and 128 layouts of a spotting head;

FIG. 12c shows a microarray slide;

FIGS. 12d-12j show a number of macrocompartment layouts and sizes, which may be used in an experimental example of a method of dilution series of samples for quantitative and multiplexed characteristic measurements; and

FIGS. 13a-13e show an experimental immunoassay layout and results which confirm the presence of cross-reactivity between pairs of antibodies in known immunoassay formats.

### DETAILED DESCRIPTION OF THE PREFERRED EMBODIMENTS

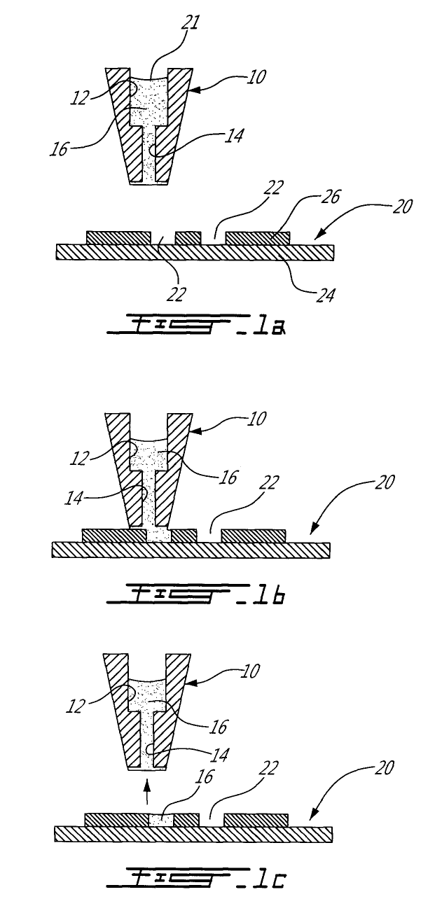

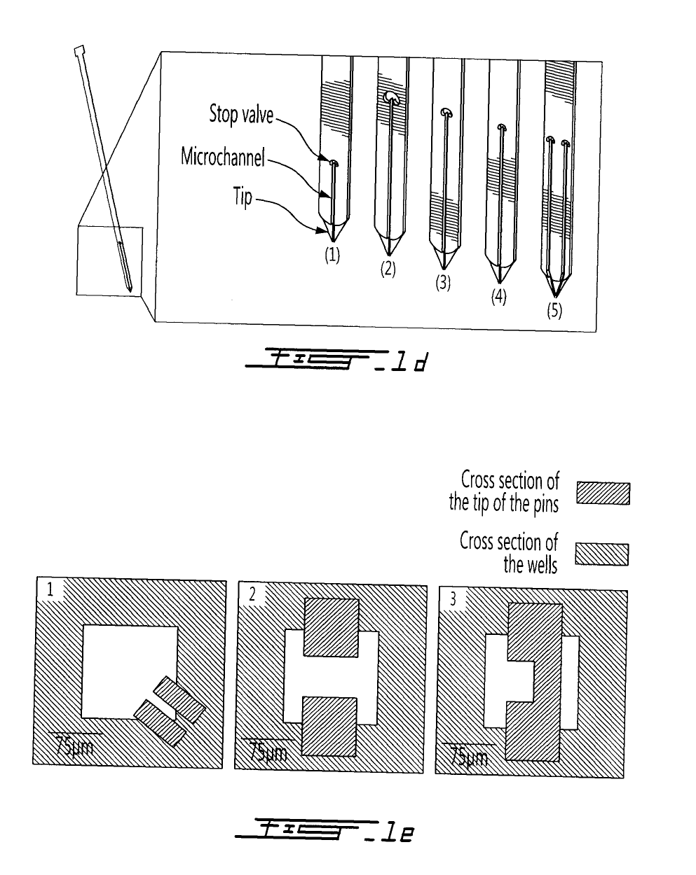

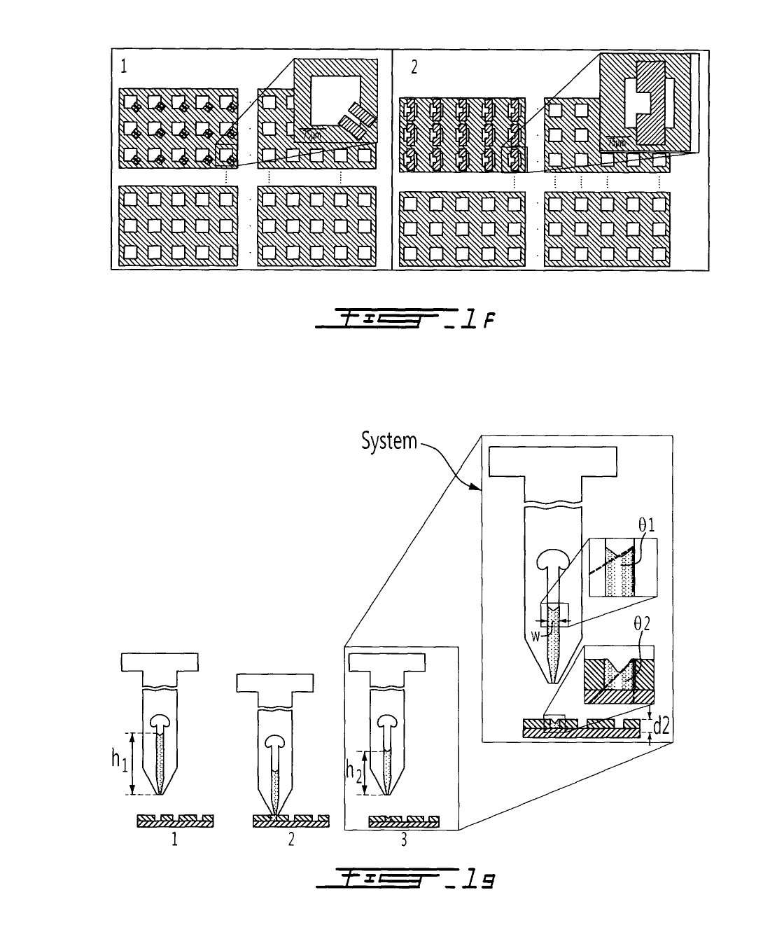

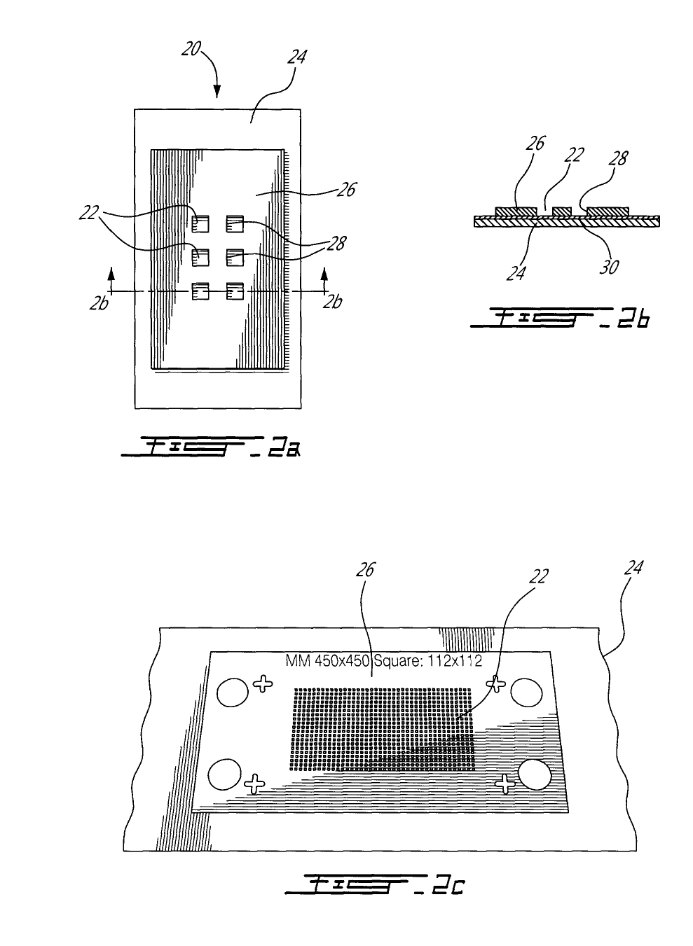

Referring to FIGS. 1a-1c, the method and system used to deliver one or more fluid solutions to the microcompartments of a microarray is shown. As seen in FIG. 1a, a reservoir or liquid transfer needle 10 of a microfluidic microarray system includes a reservoir 12 therein which is filled with a liquid 16. The reservoir 12 is in fluid flow communication with, and makes up part of, a fluid conduit 14 defined in the tip of the liquid transfer needle 10. The terms “needle” and “pin” and “capillary” will both be used herein to describe such a liquid transfer needle in a fluid handling and distribution portion of larger microfluidic microarray system of the present invention. The liquid 16 is maintained and thus held back within the fluid conduit 14 by a capillary pressure P1 generated at the interface 21 of the liquid 16 in the reservoir 12. The needle 10 is located above a microarray 20 having at least one microfluidic microcompartment 22 defined therein. Although a variety of different sizes and shapes of the microfluidic microcompartment 22 are possible, such microcompartments may for example be approximately between 50 and 150 micrometers (μm) in cross-sectional width (i.e. diameter in the case of a circular microcompartment well and length or width in the case of a square shaped compartment), and the microcompartments may be spaced apart by distance substantially corresponding to the cross-sectional width of each of the plurality of microcompartments (the spacing may however be less than or greater than the individual microcompartment widths). In one particular embodiment, for example, the microcompartments are between 100-150 μm is cross-sectional width and are spaced apart in the microarray by about 100 μm. It will therefore be appreciated that the microscopic sizes involved render the accurate delivery of fluid (for example 3-4 nano-liters) to each microcompartment for the present purposes much more difficult that for other macroscopic applications (whether biomedical related applications or otherwise) where transfer of fluid is required. The terms microcompartment and nanocompartment may be used herein to refer to such microfluidic compartments.

The microarray 20 with the microcompartments can be a monolithic or sandwich structure. As will be described further below, the microfluidic microcompartments 22 may be defined between the substrate 24 and the mask 22 that may be reversibly sealed to one another. The pin can be made of any material such as Si, polymers PMMA, PC, Zeonor, Cyclic Oleofins Copolymers, etc, photopolymers such as SU-8, metals, or glass combinations thereof. The substrate can be made of glass, polymers such as PMMA, PC, Zeonor, Cyclic Oleofins Copolymers, etc., metals, Si, or Silicon oxide or combinations thereof.

FIG. 1b shows the transfer of liquid 16 from the reservoir 12 and the fluid conduit 14 into one of the microcompartments 22. The transfer of fluid takes place automatically upon engagement in fluid flow communication of the needle 10 with the microcompartment 22, due to a capillary pressure P2 of the microcompartment 22 which is more negative than the capillary pressure P1 of the reservoir 12 and fluid conduit 14. Although direct contact is not necessary, a defined amount of liquid may be transferred to the microcompartment upon contact between the liquid transfer needle 10 and the microfluidic microcompartment 22. The capillary pressure P2 generated by the microcompartment acts, in at least one possible embodiment, in a direction which is substantially aligned with the liquid transfer needle, which may be in a substantially vertical direction for example. Regardless, due to the difference in capillary pressures P1 and P2 between the needle 10 and the microcompartment 22, the liquid 16 within the needle is “sucked” into the microcompartment 22 until it is filled. When the microcompartment is filled, it no longer generates a negative capillary pressure, and thus the flow of fluid from the needle to the microcompartment is automatically interrupted. Upon disengagement of the pin 10 from the surface of the microcompartment, as shown in FIG. 1c, the liquid 16 remains separately in the microcompartment 22 and in the needle 10. The same needle 10 can then be used to service multiple such microcompartments 22 in sequence, until the reservoir 12 is empty.

The fluid conduit 14 defined in the needle 10 may have a variety of suitable shapes, however in certain embodiments the fluid conduit 14, and possibly also the reservoir 12 as well, defines a cross-sectional area that is any one of round, oval, rectangular, square, trapeze, spear, star-shaped, triangular and hexagonal in shape (i.e. cross-sectional profile). In fact, both the fluid conduit in the needle and the microcompartments of the microarray can be formed having any one of a rounded, oval, rectangular, square, triangular, trapeze, spear, star-shaped and hexagonal shape, as well as any combination thereof. The fluid conduit 14 may be substantially closed, or alternately it may be open to atmosphere (as schematically depicted in FIGS. 1a-1c for example). Alternatively, some sections of the pin may contain a porous or fibrous material that generates a capillary force. The fluid conduit 14 within the needle 10 may have a constant cross-section, however in one particular embodiment the fluid conduit 14 has a variable cross-section with at least two different dimensions at different locations thereof. As depicted, the reservoir 12 has a larger cross-section that the outlet portion of the fluid conduit 14. The outlet portion of the fluid conduit 14 may however also itself comprise more than a single cross-sectional shape and area. As such, in one embodiment, a first capillary pressure P3 is generated in a lower portion of the fluid conduit 14 having a first dimension and a second capillary pressure P4 is generated in an upper portion of the fluid conduit 14 having a second dimension, and wherein P3<P2<P4.

In one possible alternate embodiment, a pressure controller may also be provided and disposed in communication between a pressure source and the liquid transfer needle 10, the pressure controller being operable to vary the withholding pressure P1 generated within the fluid conduit 14 of the fluid transfer needle 10. Referring now to FIGS. 1d to 1f, a particular embodiment of the fluid transfer system and method to such microcompartments is shown. During the course of experiments conducted, different pins (i.e. fluid transfer needles 10) with different liquid handling capacity were designed to transfer liquid to the micro-wells (i.e. microcompartments 22 of the microarray 20). In order to allow the fluid transfer pins to take in a very accurate amount of liquid, a stop valve is provided at the inner end of the microchannel, that is away from the tip of the pin. Liquid stops once it reaches this valve, thereby enabling a very accurate amount of liquid to be drawn into the pins and therefore transferred from the pin into the microcompartments. These “split” pins may be made of plastic and in at least this embodiment are about 30 mm long, with a width of 1000 μm and a thickness of 200 μm. As can be seen from the five different designs shown in FIG. 1d, the split pins may have different sizes of stop valves (pins #2, 3 and 4) which may be used for low volume liquid handling, or may have two fluid microchannels therein (as per pin #5), which can be sued for large volume liquid handling.

To avoid the mechanical transferring of the proteins on the surface of the microcompartment, and to prevent damaging the tip of the pin (fluid transfer needle) during the spotting (i.e. fluid transfer) process, one dimension of the pins may be larger than the length/width of the wells so that the tip cannot be completely inserted into the well/microcompartment, or precise alignment of the pin arrays with the microarray is ensured so that the tips of the pins touch only the edges of the wells. FIGS. 1e and 1f show three possible tip types and two possible mechanisms used to fill the microcompartment wells using different pins. For example, FIG. 1e shows three relative cross-sectional sizes and configuration of the pin tips versus the microcompartment well size. In configuration no. 1 shown, a silicon pin having a sharp tip of 75 μm×75 μm comes into contact with one of the edges of the well, and then liquid is transferred to the well due to capillary pressure which is stronger in the well (as described above). In this configuration, the tip of the pin has a cross-sectional area that is smaller than that of the well (microcompartment). In configuration no. 2 shown in FIG. 1e, a thick split pin of 200 μm×75 μm is shown, with the width larger than the length/width of the wells. Therefore, in this configuration, the overall cross-sectional area and/or perimeter of the tip of the pin is greater than that of the microcompartment well, and the tip is split into two separate and spaced apart prong portions between which is defined the fluid conduit microchannel extending therebetween. In configuration no. 3 shown in FIG. 1e, a thick split pin also of 200×75 μm is shown, but having a semi open fluid conduit microchannel. Thus, in this configuration, the overall cross-sectional area and/or perimeter of the tip of the pin is also greater than that of the microcompartment well, however the two prong portions of the tip are integrally formed such as to define a closed-bottomed channel therebetween. This channel defines the fluid conduit microchannel for the delivery of the fluid from the tip.

In FIG. 1f, the simultaneous filling of the microcompartment wells with the pin arrays is shown, using two possible configurations. For the configuration no. 1 shown, silicon pins with a tip size of 75 μm×75 μm are used, however a high accuracy alignment of all system components, including the microwell array chips, pins, pin holder, and the nanoplotter is needed. A total error of about ±35 μm is acceptable, as ideally an overall tolerance of the system should be less than about 35 μm. For the configuration no. 2 shown wherein thick split pins are used to simultaneously fill the wells, a larger tolerance of 110 μm can be even acceptable, enabling the synchronous filling of the wells.

As noted above with respect to FIG. 1b, transfer of fluid from the reservoir 12 and the fluid conduit 14 into one of the microcompartments 22 takes place automatically due to a capillary pressure P2 of the microcompartment 22 which is more negative than the capillary pressure P1 of the reservoir 12 and fluid conduit 14. Further details of the design of the microchannel in the pin/transfer needle which permits this effect will now be provided, with reference to FIG. 1g.

Liquid will fill the pin's microchannel (14 in FIG. 1b), only when the hydrostatic pressure of the liquid in the microchannel is positive. In another word, the capillary force needs to be larger than the gravity force along the microchannel. So:

$$\frac{2 {γcosθ}_{adv}}{W} - ρ gh > 0 ⇒ h < \frac{2 {γcosθ}_{adv}}{ρ gW} , \qquad ( 1 )$$

where γ is the surface tension of the liquid, θ_{adv} is the advancing contact angle between the liquid and the solid (θ_{adv}˜45°), W is the width of the microchannel, g is the constant of gravity, and ρ is the density of the liquid. This gives us the first condition in the design of the microchannel. The height of the microchannel therefore needs to be smaller than

$$\frac{2 {γcosθ}_{adv}}{ρ gW} .$$

To transfer the liquid to the wells, the energy balance needs to be favorable, satisfying the first rule of thermodynamics. FIG. 1g schematically shows the transfer of fluid from the pin to the wells which occurs during the transfer of fluid (i.e. the “spotting” process). The system is defined as a pin and a micro-well, where h1 is the height of the liquid before filling the desired micro-well, h2 is the height of the liquid after filling the desired micro-well (and therefore h1−h2=Δh), d2 is the depth of the micro-wells (d2˜100 μm, the size of the other two edges are 150 μm×150 μm), θ1 is the receding contact angle between the liquid and the solid surface of the microchannel (θ1˜30°), θ2 is the advancing contact angle between the liquid and the surface of the wells)(θ2˜45°), and W is the width of the microchannel, which needs to be estimated (the depth of the microchannel is 200 μm).

Therefore writing the free surface energy (Gips function) of the system before and after spotting process,

Δ₁₋₃G_{Pin}+Δ₁₋₃G_{well}<0 [symbol] (γ_{LV}ΔA_{LV}+γ_{SV}ΔA_{SV}+γ_{SL}ΔA_{SL})_{Pin(1-3)}+(γ_{LV}ΔA_{LV}+γ_{SV}ΔA_{SV}+γ_{SL}ΔA_{SL})_{microwell(1-3)}<0, (2)

as in both pins and microwells (with good approximation), only two interfacial areas (i.e ΔA_{SV}, and ΔA_{SL}) change and exactly compensate each other, equation 2 can be written as:

(γ_{SV}−γ_{SL})|ΔA_{SV}|_{Pin(1-3)}+(γ_{SV}−γ_{SL})|ΔA_{SV}|_{microwell(1-3)}<0 (3)

Using Young's equation:

γ_{LV} cos θ=γ_{SV}−γ_{SL}

γ_{LV} cos θ₁|ΔA_{SV}|_{Pin(1-3)}+γ_{LV} cos θ₂|ΔA_{SV}|_{microwell(1-3)}<0 (4)

Knowing the geometry of the micro well, a minimum width for the microchannel is estimated.

$$Δ h = \frac{112.5 \times {10}^{- 12}}{W} ⇒ For the present exemplary embodiment , \\ W \sim 100 μm .$$

The above can therefore be used to design and determine the necessary characteristics of the fluid transfer needles (pins) require in order to ensure that the hydrostatic pressure of the liquid in the pin's microchannels is positive, and thus to ensure the transfer of the fluid by capillary pressure from the microchannel of the pin to the microcompartment well of the microarray.

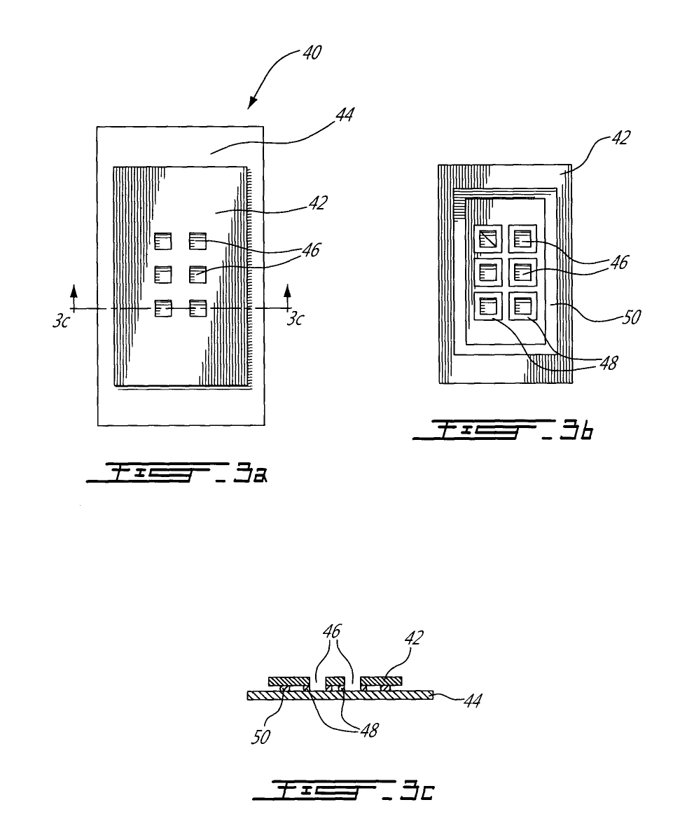

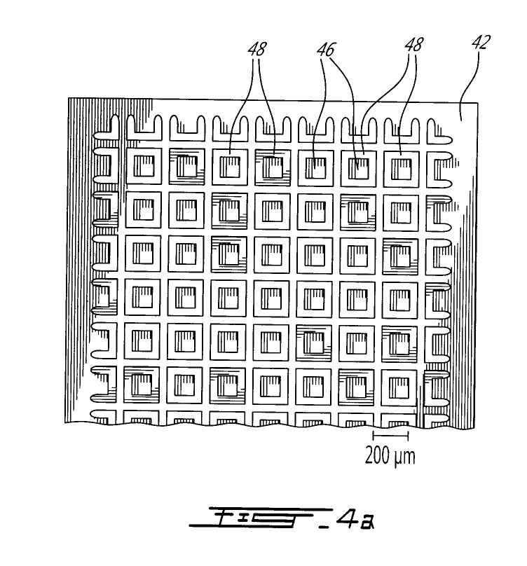

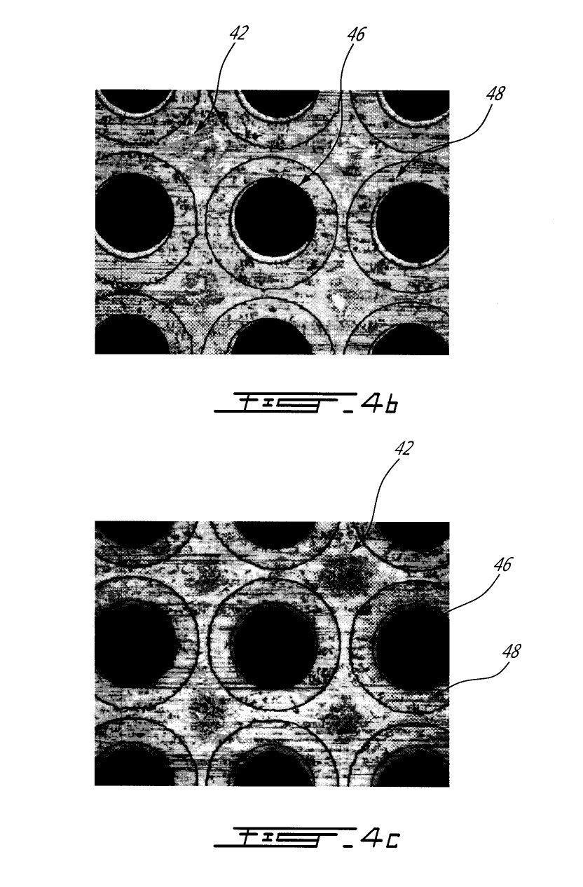

Referring now to FIGS. 2a-3c, an embodiment of the present microarray 20 having the microcompartments 22 defined therein is depicted and how these are formed. As seen in FIG. 2a, the microarray 20 includes a solid substrate or support 24 to which is applied a thin microfluidic mask 26 having openings 28 therein which define the microcompartments 22 once the mask 26 is sealed onto the solid support 26. Although six such microcompartments 22 are shown, it is to be understood that more or less can be provided.

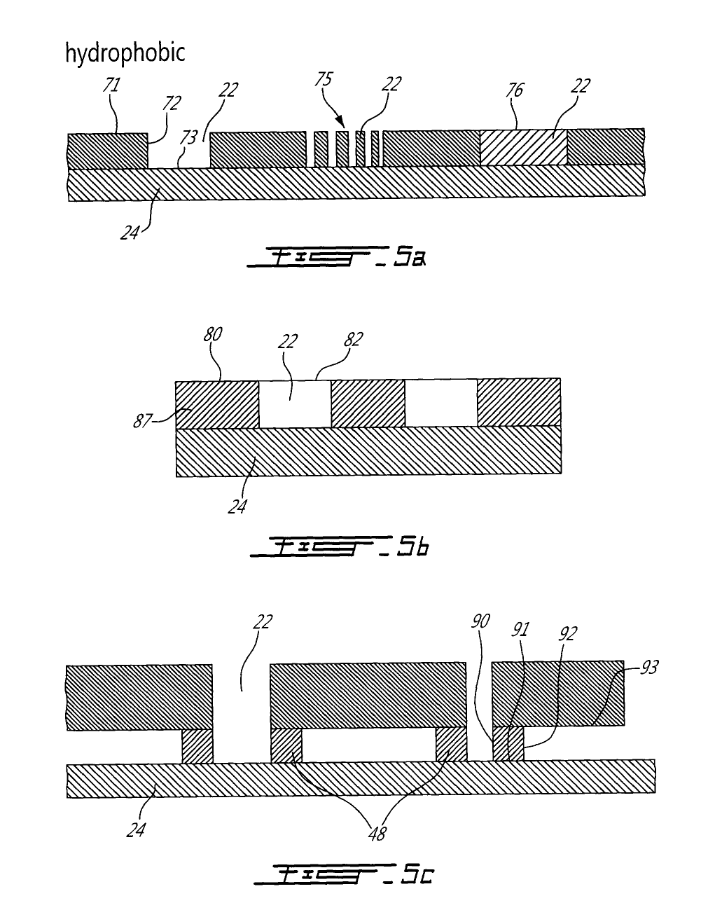

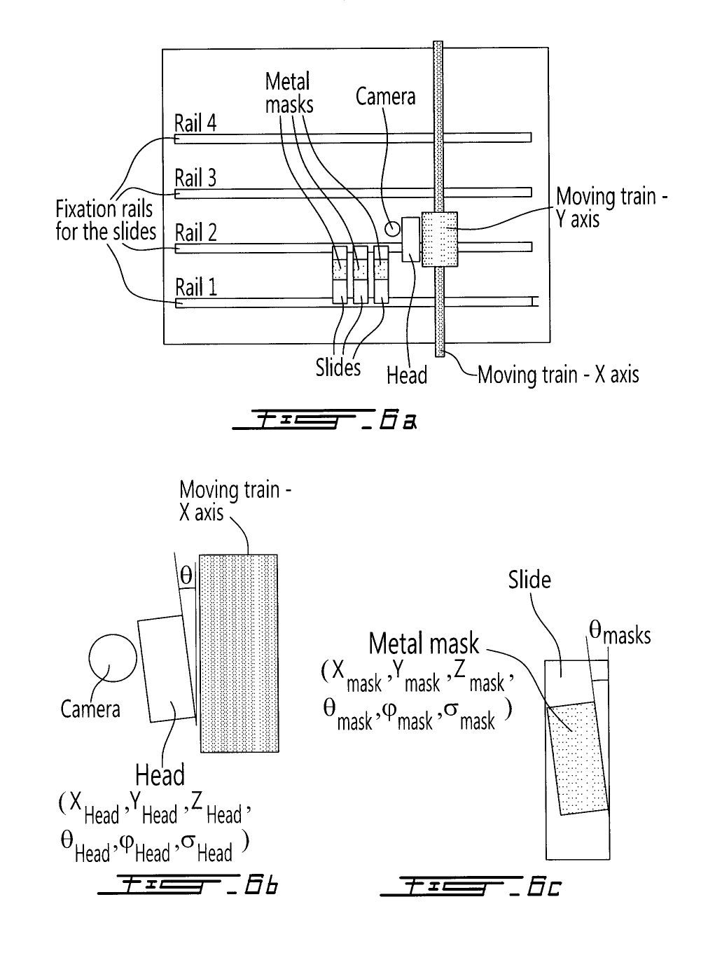

As seen in FIG. 2b, the microfluidic mask 26 is sealed to the solid support 26 using an intermediate sealing layer 30 which covers the solid support 26. The sealing layer is preferably made up of an elastomeric material that forms a liquid tight seal with any smooth solid support (such as the substrate slide 24 and the microfluidic mask 26) after applying the microfluidic mask 26 to it. In at least one embodiment, the sealing layer 30 is composed of a number of rings (see FIG. 4) which are aligned with and surround each of the openings 28 in the microfluidic mask 26, such as to seal off each of the individual microcompartments 22. Alternatively, the rings can be fixed reversibly or irreversibly on the substrate slide 24. The rings can be made of Poly (dimethylsiloxane) (PDMS), Polyurethane, photopatternable RMS-033 (Gelest company), photopatternable polymers FIP series (Dymax corporation) or any other elastomeric material. The microfluidic mask 26 can be made of a metal such as steel, or a polymer such as Polymethylmethacrylate (PMMA), Polyethylene therephtalate (PET), Kapton, polycarbonate or any other suitable material, or a combination of these materials. Preferably, however, the microfluidic mask 26 is made of a rigid material that can prevent distortion of the mask when it is being handled. A microfluidic mask 26 made of steel is shown in FIG. 2c, which has been sealed onto a transparent glass slide 24 having a transparent sealing layer 30 covering it. The microfluidic mask 26 of the embodiment shown has an array of a plurality of microfluidic microcompartments 22 which are 112×112 micrometer̂2 in size and separated by 450 micrometers from center-to-center. A micrometer (μm) is understood to be one millionth of a meter, i.e. 1×10⁻⁶ m (which can alternatively be expressed one thousandth of a millimeter). A micrometer is also commonly known as a micron.

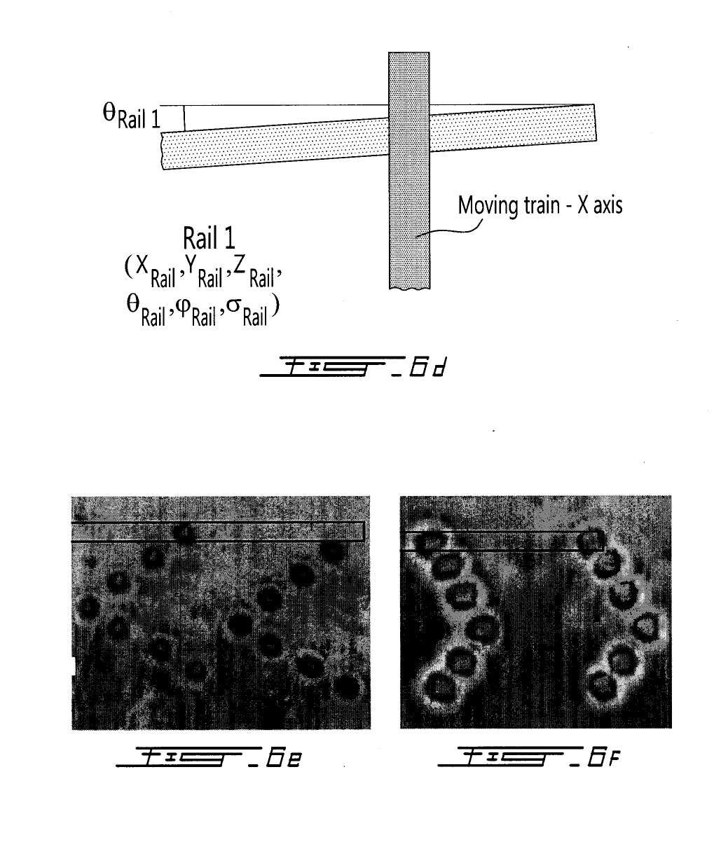

Another embodiment of the present invention is shown schematically in FIGS. 3a-3c, in which a self-sealing microfluidic mask is used. In the microarray 40, the microfluidic mask 42 is sealed to a solid support 44. The underside of the microfluidic mask 42 is visible in FIG. 3b. As can be seen, the bottom surface of the mask 42 includes integrated sealing rings 48 which surround each of the microcompartments 46 and which form a liquid tight seal when the mask 42 is placed onto a smooth solid substrate 44 such as a glass slide. A larger sealing ring 50 which surrounds the entire array of openings/microcompartments 46 may also be provided in addition to the individual sealing rings 48. FIG. 3c shows the microfluidic mask 42 sealed against the solid support 44. In this embodiment, it is possible to use conventional glass slides which are available from a large number of sources as the solid support 44. In another embodiment, it would be possible to use for example an elastomer as the sealing ring 50 while using hard materials as the sealing rings 48 but with a special surface treatment to control the wettability, as will be described further below with reference to FIGS. 5a-5c.

FIG. 4a shows a microfluidic mask 42 of FIGS. 3a-3c, the mask 42 having sealing rings 48 arranged in a configuration around each of the openings in the mask which form the microcompartments 46. The rings are formed of an elastomeric sealing layer as described above relative to FIG. 2c. The sealing rings 48 could alternatively also be fixed to a glass slide, and the mask 26 shown in FIG. 2c could then be sealed onto the sealing rings 48. of this example are made of an glass slide covered. As shown in the FIG. 4a, each of the square sealing rings 48 is approximately 200 μm in size. FIGS. 4b and 4c depict microscope images of an alternate embodiment wherein the microfluidic mask 42 sealed on a rigid, flate substrate surface creates circular microcompartments 46 enclosed by the elastomeric rings 48. As seen from the scale shown in the figure, each of the microcompartments are approximately 150 μm in diameter. In FIG. 4c, the microcompartments 46 have been loaded with an aqueous solution, which was dyed red for visualization purposes. As can be seen, the aqueous solution is contained within each microcompartment by the elastomeric rings 48.

Referring now to FIGS. 5a-c, which depict particular embodiments of the present microarray 20 and microcompartments 22. As seen in FIG. 5a, the inner surfaces 72 and 73 of the microcompartment can be made wettable and the outer surfaces can be made non-wettable. Wettable and non-wettable are described in detail further below, and correspond to hydrophilic and hydrophobic in the case when water is used as a liquid. Having a wettable microcompartment will decrease the capillary pressure of the compartment and help transfer the liquid. Having a non-wettable outer surface will help prevent liquid from spreading on the top surface of the compartment when the pin 10 and the microcompartment 22 are in fluidic communications. The chemical composition can be made of glass or a metal, and can be tuned by using self-assembled monolayers such as thiols or silanes. The thiols and silanes with wettable end-groups can be patterned to the inside of the microcompartment. Thiols and silanes with non-wettable end-groups can be patterned to the outside of the microcompartment. Photolithography and other microfabrication methods may be used to pattern hydrophobic polymers such as Teflon™ of CF4 on the outside of the microcompartments. In another alternate version of the microcompartment 22 it is substructured with pores 75, which can also help further reduce the capillary pressure P2. The pores can be made wettable as described previously. In yet another embodiment, the microcompartments may be filled with a gel, or a porous material 76 which allows the reagent to diffuse to the surface of the microcompartment.

Referring now to FIG. 5b, the microcompartments can be formed by changing the liquid permeability of a membrane, a porous material or a screen 80 by for patterning an impervious material on top or inside the membrane. Thus, the area 81 is impervious to the liquid, whereas the area 82 is permeable to the liquid and forms a microcompartment 22 atop of the substrate 24.

Referring now to FIG. 5c, a microcompartment 22 with rings 48 can be made using soft, elastomeric rings as described before, or using hard rings. When using hard rings, there is no liquid tight seal per se with the surface. However, by adjusting the wettability of the rings, that is by making the external surfaces 92 and 93 non-wettable, it is possible to confine the liquid within the microcompartment 22 atop the substrate 24. The surface 91 can also be made non-wettable to further help the confinement. The surface 90 is preferably wettable to assist the liquid to reach the surface and to generate a negative capillary pressure when filling microcompartment 22. The wettability can be patterned using photolithography, microfabrication, or microcontact printing of self-assembled monolayers. A surface is typically said to be “wettable” by a liquid if the contact angle between a drop of the liquid and the surface is less than 90 degrees. A cavity for carrying a liquid is typically wettable if the cavity exerts a negative pressure on the liquid when partially filled. Such a negative pressure promotes filling of the cavity by the liquid. In a cavity having a homogeneous surface, a negative pressure arises if the contact angle between the liquid and the surface is less than 90 degrees. A surface is typically regarded as more wettable if the contact angle between the surface and the liquid is smaller and less wettable if the contact angle between the surface and the liquid is higher.

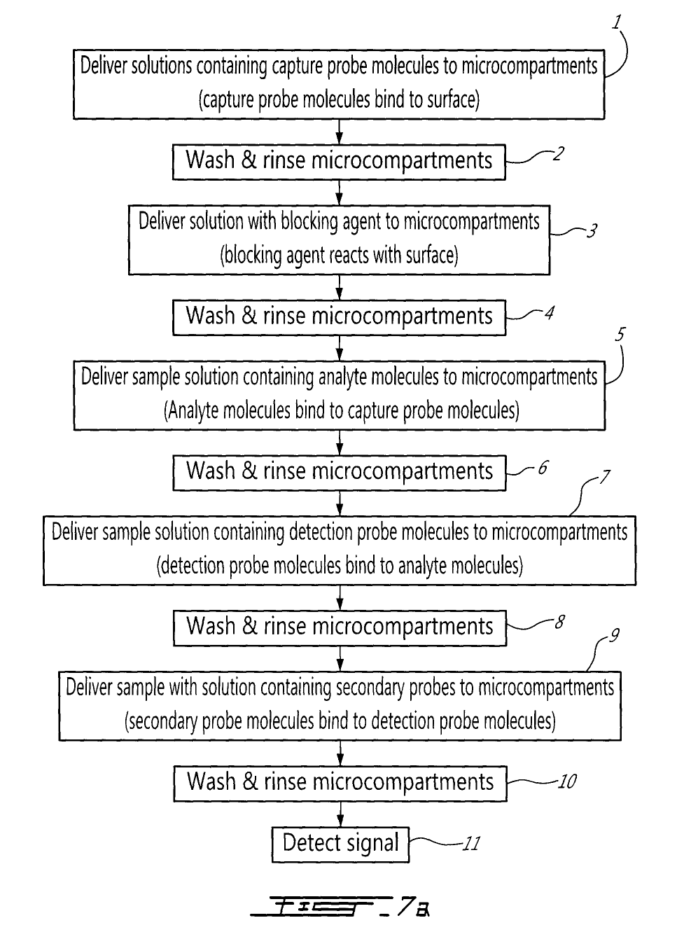

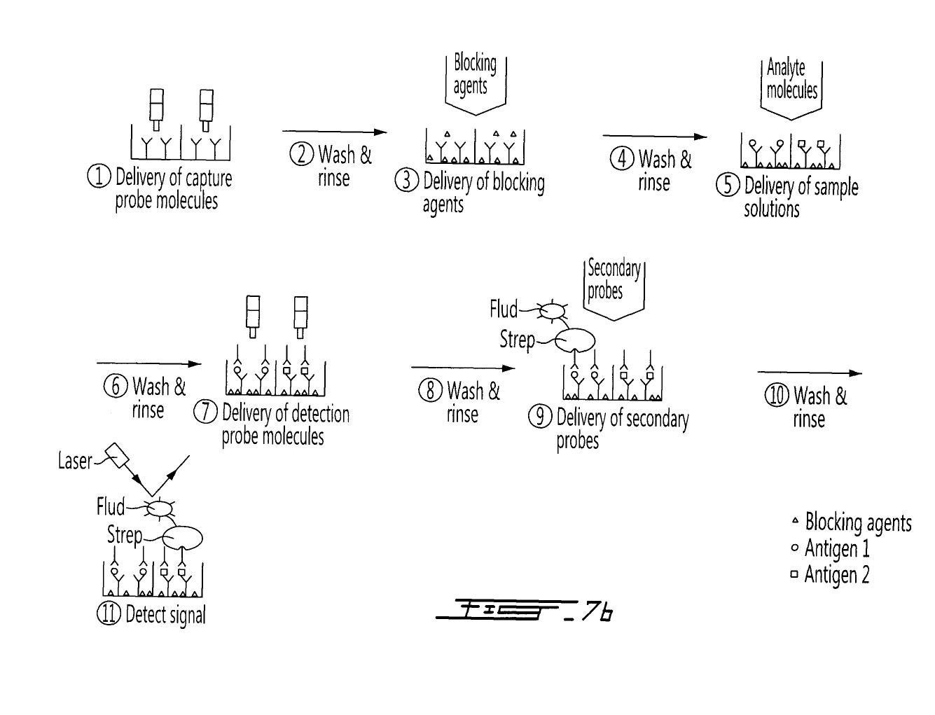

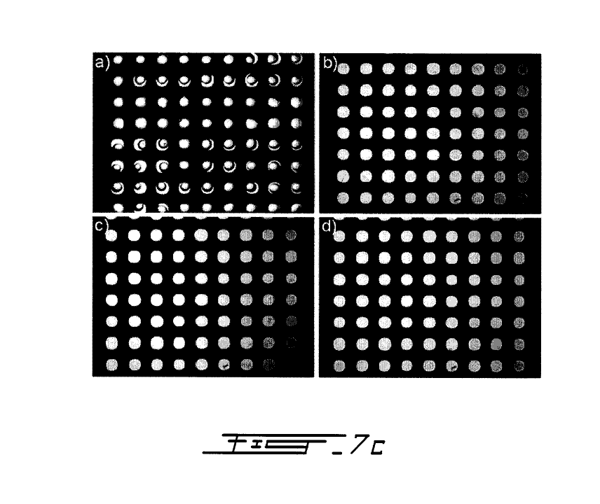

FIG. 6a-6f depicts the alignment system used to ensure accurate and repeatable spotting into an array of microfluidic microcompartments. In conventional (i.e. prior art) microarray printing system, microarrays are obtained by a single step printing and therefore do not require a high resolution alignment system. In the present system, however, a high resolution alignment system was developed in order to ensure that a specific edge of a microcompartment of only a few micrometers in size can be accurately aligned for spotting. FIG. 6a shows the main printing system which includes a main plate to which four rails are fixed, and a moving train element which moves in three dimensions (along X, Y and Z axes). A head is fixed to the moving train element and comprises the needle array holder. The rails are the slides fixation structures, and the metal mask which comprise the microcompartments therein are fixed to the slides. The alignment of the needle holder of the head and the glass slides is critical. Each of these elements has X, Y, θ, φ, σ deviation, where θ is the tilt angle according to the moving axes, and φ, σ are the tilt of the surface of the main plate according the X and Y axes. φ, σ can be neglected assuming that mechanical fatness of the main plate. This system is equipped with a camera that allows image recognition of the metal mask and is therefore capable of correcting the X and Y deviation.

Referring particularly to FIGS. 6b-6d, the main alignment issue is the tilt angle θ of each element, which can together add up to create a significant misalignment error unless they are carefully controlled. With the present system, the needles array is in one possible embodiment about 40 mm long, which would yield to a misalignment of 70 μm with a tilt angle of 0.1°. In order to achieve a more accurate alignment (i.e. less than 20 μm error), the overall tilt angle must be lower than 0.03°. The overall tilt angle is measured with the image recognition system. The target is rejected if it does not match user set limits. Many alignment mechanics have been designed and integrated to the present system. In experiments conducted, an overall tilt angle of 0.07° has been measured so far.

The alignment of the rails must also be controlled. The four rails are fixed on the main plate should, in theory, all be exactly parallel; therefore the adjustment of the tilt of rail 1 would guaranty the alignment of all the slides on the main plate. Each rail's tilt angle (θ_{Rail1}, θ_{Rail2}, θ_{Rail3} and θ_{Rail4}) may however differ slightly, such as due to mechanical fabrication tolerances and its fixation to the main plate, etc.

Head alignment is another possible contributing factor. The head is the needle array holder. The tilt angle θ_{Head} is obtained by measuring the deviation in the X axis between the first and the last needle of the same row in the needles array. The tilt angle θ_{Head} is corrected by adjusting a small knob on the system that moves the head around a pivot to vary head alignment as desired. As seen in FIG. 6e, misalignment of the head can result in misalignment between adjacent microcompartments. FIG. 6f shows the properly aligned microcompartment spotting when the head is itself accurately aligned.

The metal mask on each slide must also be accurately aligned. The metal mask is fixed to the glass slide by a polymer, and this must be done in a manner which ensure accurate alignment of the mask and the slide. The mask fixation step is very important, as it determines (assuming all other tilt angles are null) the tilt angle measured by the camera. An alignment mechanism based on one flat plan reference fixation was thus fabricated. It consists of putting the slide and the mask vertically on the same flat surface and putting them together. The tilt angle therebetween is thus as small as the reference surface is flat.

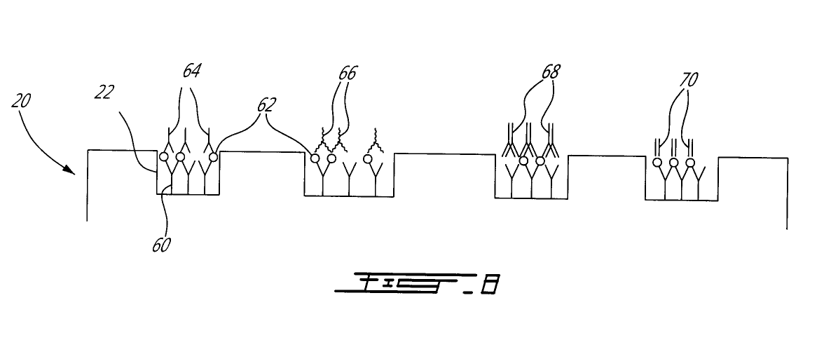

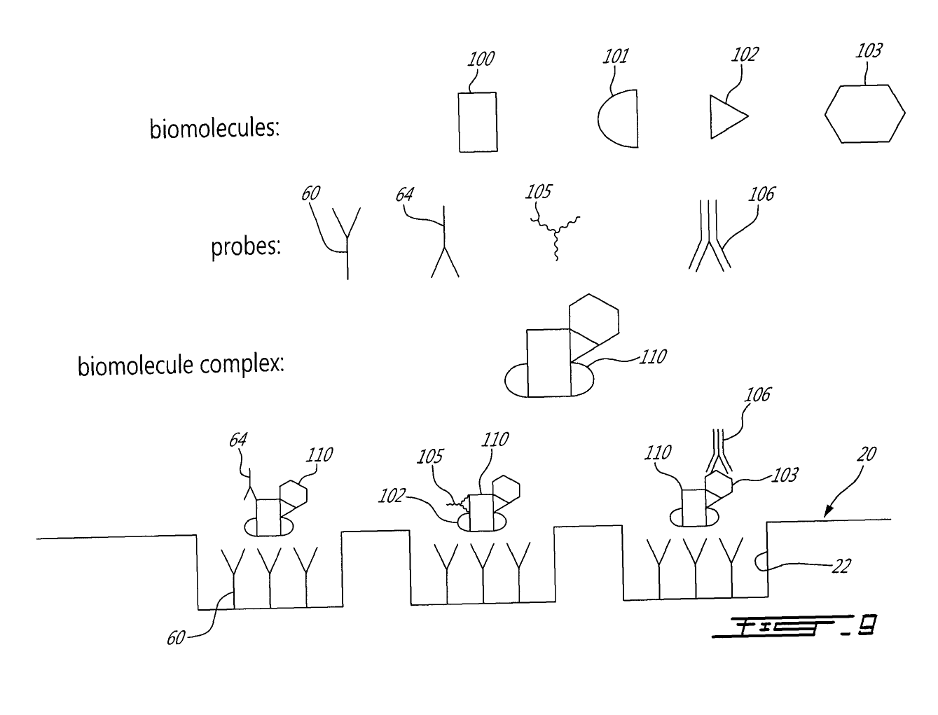

Referring now to FIGS. 7a and 7b, a process flow for performing a sandwich assay is shown. The microcompartments can be used to carry out solid-phase assays by adsorbing or attaching the capture probe molecules to the substrate 24. In this way, the samples can be washed out, and the microcompartments 22 rinsed without the capture probe molecules, and subsequently the analytes and detection probes being washed away. The process flow in FIG. 7a describes an assay involving a secondary probe tagged with a fluorophore, a fluorescent nanoparticle, or a radiolabel. Alternative protocols will be obvious to the skilled in the art, such as a protocol where the detection probe is labeled, which can shorten the number of steps. In another embodiment, the secondary probe can be conjugated to an enzyme, in which case additional steps are necessary to deliver a solution containing the substrate to the microcompartment, which is then converted to a readable signal by the enzyme, and followed by the addition of a stop solution to stop the reaction of the substrate after a defined time.

The method/process of FIGS. 7a-7b involves principally the steps of: 1) delivering capture probe molecules in solution to the microcompartments; 3) delivering blocking agents in solution to the microcompartments; 5) delivering analyte molecules to the microcompartments; 7) delivering detection probe molecules to the microcompartments; 9) delivering secondary probe molecules to the microcompartments; and 11) detecting a signal from each of the microcomparments, using for example a laser. A step of washing and rinsing the microcomparments between each of the above steps is preferably also performed.

As seen in FIG. 7c, during the processing steps such as washing, rinse and blocking, air bubbles may get trapped on microcompartments. Air bubbles are seen in the upper left hand slide (slide “a)”) of FIG. 7c. Removal of these trapped bubbles is important during the processing steps. Accordingly, a slide centrifuge or ultrasonication process is preferably used to effectively remove any air bubbles trapped. The upper right hand slide (slide “b)”) of FIG. 7c shows the air bubbles removed. This ultrasonication step accordingly eliminates the presence of bubbles trapped in the microcompartments during subsequent blocking and washing steps (shown in slides “c)” and “d)” of FIG. 7c) without any new air bubbles forming, thereby ensuring proper washing and incubation procedures.

Turning now to several possible embodiments of the present method for multiplexing microarrays which includes, for example, individually delivering at least a first fluid solution containing a capture probe to each of the microarray's microcompartments using a capture probe, and individually delivering at least a second fluid solution to each of the microcompartments using a cognate detection probe.

FIG. 8 schematically depicts a microarray 20 having a number of microfluidic microcompartments 22 therein, into which has been introduced a number of fluidic agents in a sequence similar to the one described in FIGS. 7a and 7b. For example, capture antibodies 60 and analytes 62, have been delivered to all microcompartments, but subsequently a variety of different solutions have been added into different microcompartments 22. Detection probe 64 have been added to a first compartment (first compartment from left in FIG. 8), detection probes 66 against a first characteristic of the protein, for example a protein isoform, have been added to a second compartment (second compartment from left in FIG. 8), detection probes 68 against a second characteristic of the protein, such as a post-translational modification, have been added to a third compartment (third compartment from left in FIG. 8), and detection probes 70 against a third characteristic of the protein have been added to a fourth compartment (fourth compartment from left in FIG. 8). The capture probe molecule may for example be a DNA, RNA, a protein or an antibody, and the analyte may for example be another protein, an antibody, DNA, or RNA.

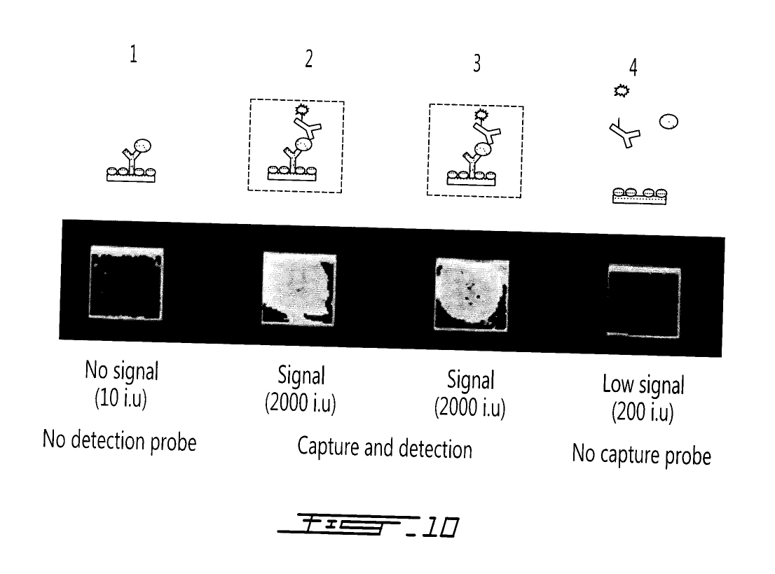

FIG. 9 shows another series of microcompartments with identical capture probe molecules, analytes, and with different detection probes specific for proteins that can form complexes with the analyte immobilized to the capture probe. More particularly, FIG. 9 schematically depicts a series of molecules that can bind together and form a complex 110. It also shows a series of probes, including probes 60 and 64, that target the same analyte 100 but bind to different epitopes, and capture probes 105 and 106 that bind to some of the molecules 101 and 103, respectively, that can form a complex with the molecule 100. FIG. 9 also schematically depicts the microarray 20 having a number of microfluidic microcompartments 22 therein, into which has been introduced a number of fluidic agents in a sequence similar to the one described in FIGS. 7a-7b. For example, capture antibodies 60 and analytes 110, have been delivered to all microcompartments, but subsequently a variety of different solutions have been added into different microcompartments 22. Detection probes 64 have been added to a first compartment, detection probes 105 against a binding partner 101 of molecule 100 have been added to a second compartment, detection probes 106 against a binding partner of molecule 102 which itself is a binding partner of molecule 100 have been added to a third compartment. The capture probe molecule may be a DNA, RNA, a protein or an antibody, and the analyte may be another protein or an antibody or DNA, or RNA. The molecules in the complex may also be DNA, RNA, proteins, as well as proteins with specific PTMs. The detection probes may only bind a protein if it has a specific characteristic modification.

A variety of additional features may also be provided in the microarrays of the present invention. Although the microcompartments depicted are shown as being substantially square, they may in fact define a cross-sectional area and shape which is alternately triangular, rectangular, star-shaped or round.

Further, in one embodiment, the inner surface of the microcompartments is wettable to the liquid and an outer surface of the microcompartment is non-wettable to the liquid being transferred. The microcompartment may also be formed by reversibly sealing a thin mask sheet with rings that feature wettability patterns, and wherein the outer edges of the rings are non-wettable.

FIG. 10 depicts experiments conducted with respect to target detection on nanocompartments. 8 nL of capture probe antibody against the target was dispensed into compartments numbers 1, 2 and 3. The sample was then incubated with 10 ng/mL of the target. 8 nL of cetection probe against the target was then dispensed into nanocompartment numbers 2, 3 and 4. As can be seen in FIG. 10, significant signal (2000 i.u) was observed only in the compartments where both capture and detection probes were dispensed—namely in compartments 2 and 3. Either no (0 i.u.) or very low (200 i.u.) signals were measured in compartments 1 and 4 which respectively had no detection probe and no capture probe therein.

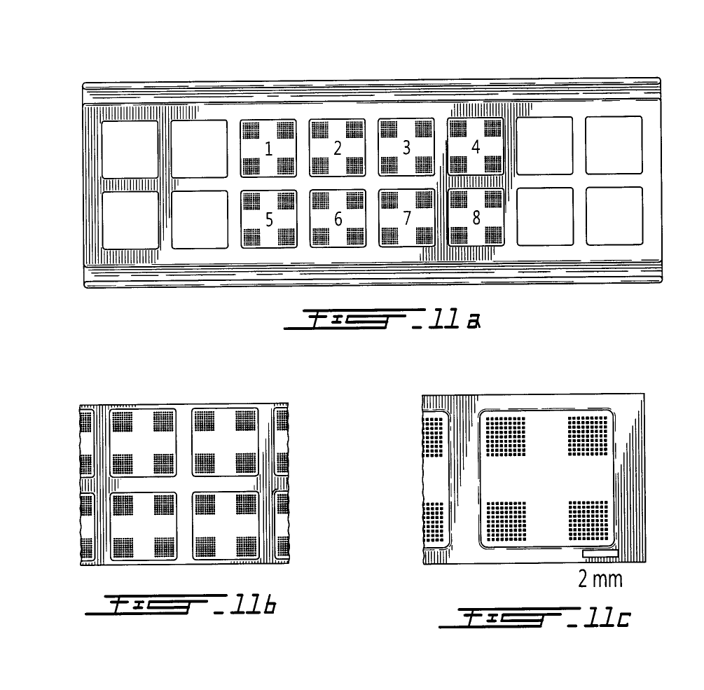

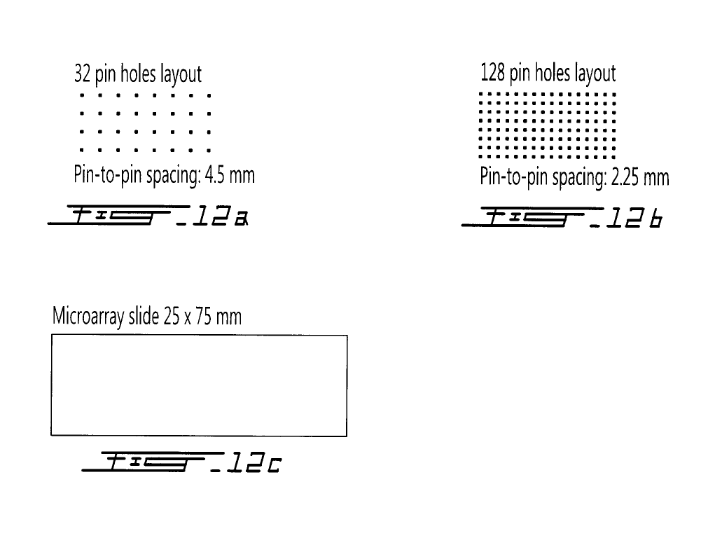

Referring now to FIGS. 11a-11c, in accordance with another embodiment, the microcompartment arrays may be further partitioned into a series of subarrays within larger macrocompartments. As such, a slide for use in a microfluidic microarray system is provided which includes microfluidic compartments thereon that are arrayed and partitioned within larger macrocompartments.

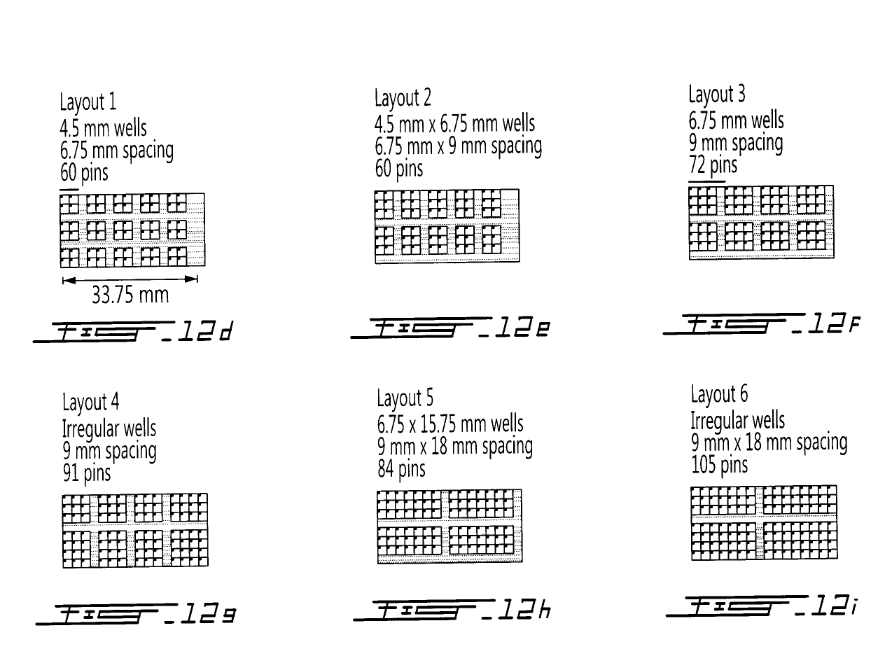

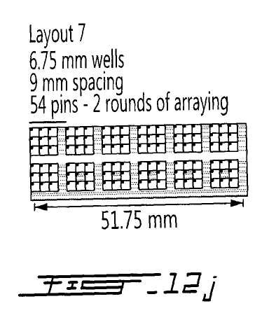

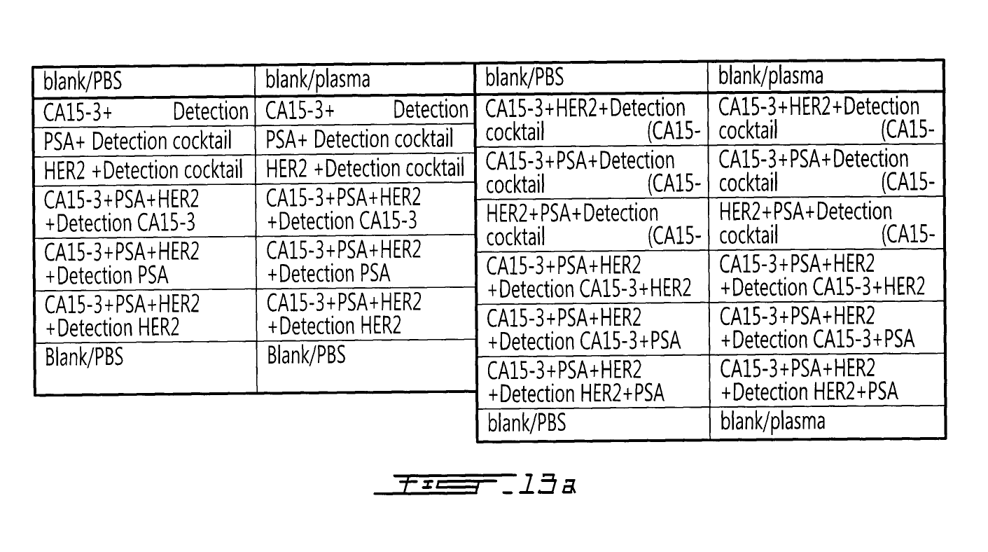

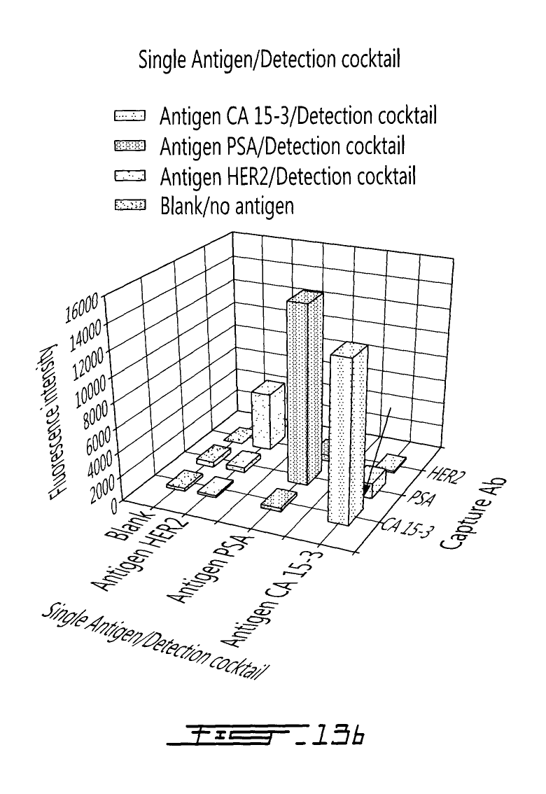

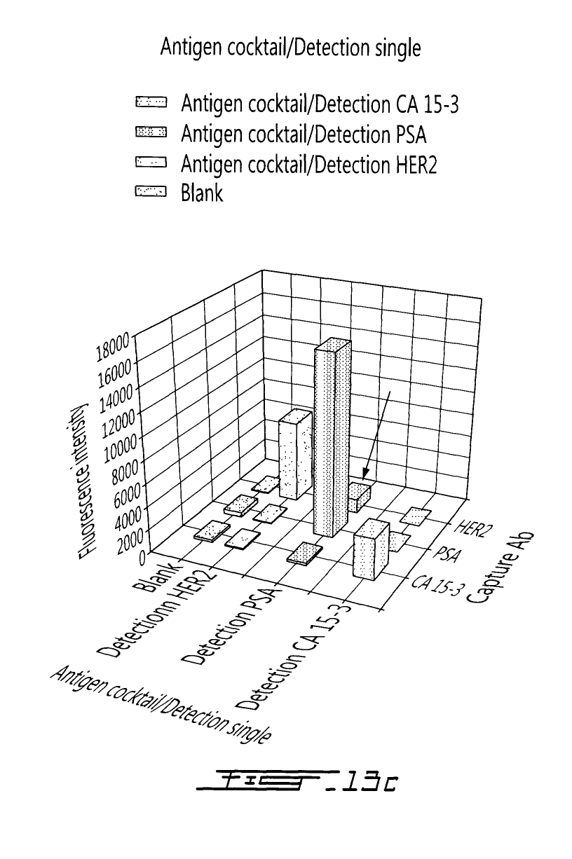

A number of micro/macrocompartment layouts are possible with the present microarrays. FIGS. 12a-12j depict a number of possible layouts of pins and macrocompartment sizes in accordance with various alternate aspects of the present invention, which can be used in for multiplexed measurement of protein concentration and protein characteristics. FIGS. 12a-12b respectively show 32 and 128 pin hole layouts. This is contrary to the prior art, where only one pin is typically used for producing a microarray within one macrocompartment or well. FIGS. 12d-12j depict a variety of configurations allowing the use of at least 2 pins to deliver liquids to microcompartments partitioned within macrocompartments and having different number of pins and sizes and/or spacing of microcompartments and macrocopmartments.

The microcompartments are, in one embodiment, formed in a microarray by first providing a solid support having openings therein, subsequently coating at least part of the solid support with a elastomer layer which may be photosensitive, and then patterning the photosensitive elastomer layer into rings which are aligned with the openings of the solid support such that the microfluidic microcompartments are defined between the solid support and the rings of the photosensitive elastomer layer. The coating can be applied by spin-coating the solid support or spin coating the photosensitive elastomer on a flat surfaces, such as a cover slip or a thin polymer sheet (i.e. PMMA or PET foil), in order to transfer the spin-coated liquid photosensitive elastomer by contacting the rigid support. In one particular embodiment, the photosensitive elastomer layer used was composed of GA-103™ produced by Dymax Corporation.

As described briefly above, an embodiment of the present invention also includes a method for delivering detection molecules into the plurality of microcompartments of the microarrays described herein, as well as delivering sample solutions and solutions containing detection biomolecules, i.e. detection antibodies into these microcompartments. This is done in a manner which substantially avoids cross-contamination (cross-reactivity) problems between the solutions. For example, in one embodiment this is done by delivering multiple solutions to a plurality of microcompartments in an microarray, by contacting a first portion of an edge of the microcompartments with a first liquid solution, rinsing away the first liquid solution, and then contacting a second portion of the edge of the microcompartments with a second liquid solution, wherein the first and second portions of the edge of the microcompartments are different.

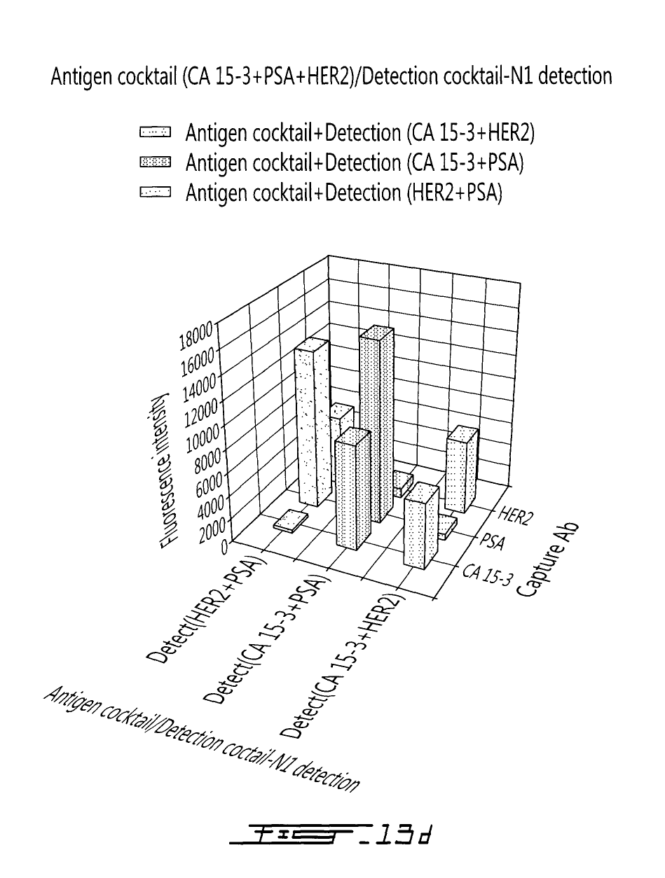

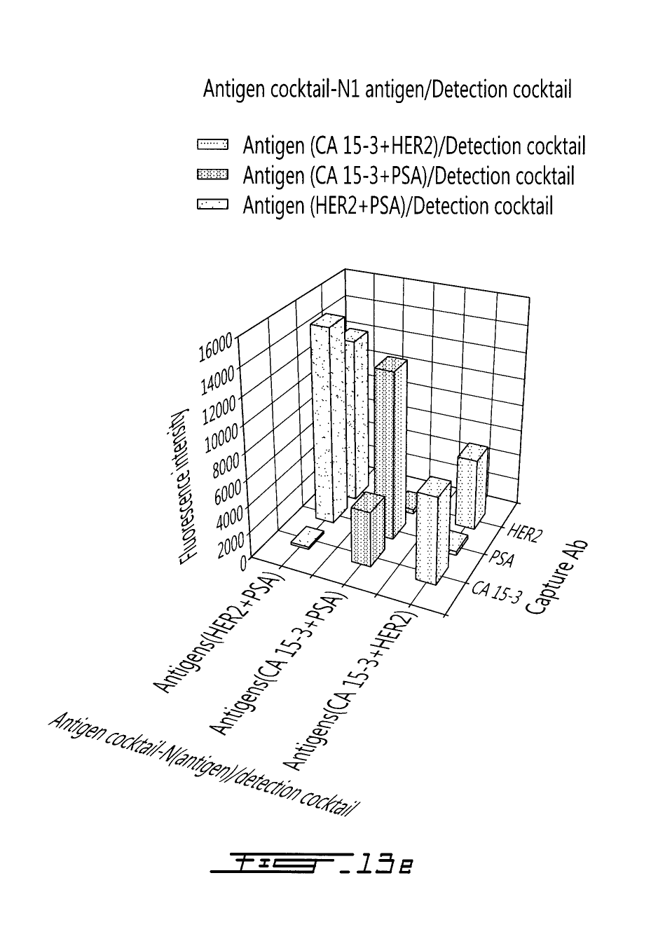

Referring to FIGS. 13a-13e and as noted above, the present system and method attempts to avoid cross-reactivity between adjacent microcompartments. Cross-reactivity experiments were conducted using prior art type multiplexed immunoassays in order to determine the likelihood of such an undesirable cross-reactivity. As an example, the cross-reactivity between four pairs of antibodies in a traditional immunoassay was measured. Four combinations of the following pairs of antibodies were measured: single Antigen+detection cocktail; cocktail of Antigens+single detection; cocktail of Antigens+(detection cocktail−N1 detection); and (cocktail of Antigens−N1 antigen)+detection cocktail. The layout of the assay was as shown in FIG. 13a. The following mAbs were spotted by 4 columns, with 5 spots in each column, on epoxy glass slides using the nano-plotter.

Negative control (Carbonate buffer, pH 9.4 + 5% threhalose)

| | |
|---|---|
| mAb CA15-3 (800 ug/ml) | Ag CA15-3 (10 ng/ml) |
| mAb PSA (600 ug/ml) | Ag PSA (5 ng/ml) |
| mAb HER2 (200 ug/ml) | Ag HER2 (0.5 ng/ml) |

The results of this experiment are shown in FIGS. 13b-13e. As can be seen by the arrow in FIG. 13b, cross-reactivity between the capture PSA and the detection Ab (cocktail) was detected without the presence of any antigen PSA. As can be seen by the arrow in FIG. 13c, the detection Ab PSA nonspecifically binds to the antigen HER2 in the antigen cocktail, therefore indicating cross-reactivity. As seen in FIGS. 13d and 13e, cross-reactivity was also detected between the remaining two pairs of antibodies measure. As evidenced by this experiment, cross-reactivity was found between the capture PSA and the detection Abs in the detection cocktail in the presence of no antigen PSA, and the detection Ab PSA was found to nonspecifically bind to the antigent HER2 in the antigen cocktail. It is exactly this cross-reactivity that the microfluidic microarray system and method of the present invention attempts to limit and/or avoid.

Multiple solutions can also be delivered in parallel to macrocompartments of a microarray which are each partitioned into smaller microcompartments. This is done by using one fluid delivery needle or pin per larger macrocompartment. The fluid delivery pins are arranged in a spotting head which is used to apply the fluid to the microarray in a given configuration which corresponds to the layout of the macrocompartments in the microarray. This can be done by arranging a plurality of the pins in the spotting head, and then removing those which overlay the partition walls which divide the plurality of macrocompartments. The fluid is then spotted, using at least one fluid delivery pin per macrocompartment, to introduce multiple fluid solutions into different ones of the microcompartments.

Microarrays defining a plurality of microcompartments therein may be multiplexed by individually delivering one fluid solution containing a capture probe to each of the microcompartments, then delivering a sample solution, either collectively or individually to each microcompartment, and subsequently individually delivering another fluid solution containing a cognate detection probe to each of the microcompartments. Another solution may also be delivered to each of the microcompartments, and this may be done using a non-cognate detection probe which is specific for a candidate protein that forms a complex with a given target protein. Additional processing steps may also be used, such as collectively rinsing all of the microcompartments, blocking the microcompartments with a blocking solution, filling the microcompartments with a sample solution, and then rinsing the microcompartments. These additional steps are preferably performed following the delivery of the first one of the fluid solutions contacting the capture probe. It is also of note that while a secondary incubation step may also be used, this is not absolutely required. Referring back to FIG. 10, the result of an assay where such capture probe and detection probe have been delivered into the same microcompartment are shown. In the microcompartments were negative controls were carried out, i.e. in compartments 1 and 4, no or very low signal was detected.

The present system can also be used for measuring specific characteristics of proteins using multiplexed microarrays defining a plurality of microcompartments. This is preferably done by delivering at least one solution with a capture probe to each of the microcompartments individually, collectively rinsing all of the microcompartments, and then delivering to at least one of the microcompartments one or more other solutions with a cognate detection probe that is specific for a characteristic of a protein, such as a particular protein isoform including ones due to genetic mutation or post-translational modifications such as phosphorylation or glycosylation, stages of protein maturation, and protein activity of an analyte, for example. The quantification of at least one analyte and/or for measuring a specific characteristic of the analyte can also be performed using such multiplexed microarrays.

Multiple analytes can also be measured with dilution series by delivering multiple solutions in parallel to a plurality of arrays of the microcompartments which are partitioned into a number of macrocompartments which can accommodate at least one fluid delivery pin per macrocompartment. This can be done by delivering at least a first solution containing a capture probe to each of the microcompartments individually, then delivering at least two sample solutions, one of which is diluted with a solvent, to two or more different macrocompartments, and then delivering at least a second solution containing a cognate detection probe to each of the microcompartments individually. The sample can be applied using a conventional pipetting robot or by manual pipetting into individual macrocompartments. Different dilutions of the samples can be used in different macrocompartments so that the optimal concentration range is found for each of the probe pairs used in the microcompartment arrays. It is also possible to deliver the samples using the pins into individual microcompartments, so as to further reduce sample consumption. Whereas several microliters are necessary to fill a macrocompartment, sample application to the microcompartments only using the pin spotter can reduce the sample consumption to a few nanoliters only. Further, by directly delivering the samples to the microcompartments, it is possible to multiplex samples and to deliver different samples to adjacent microcompartments whiles avoiding cross-contaminations. When the samples are directly delivered to the microcompartments, the macrocompartments do not have to be used.

The present invention can be combined with a variety of detection methods, including for example fluorescence, enzyme, radioassay, electrochemistry, electrochemiluminescence, quantum dots, beads, nanoparticles, or nanobarcodes.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

1-46. (canceled)

47. A microfluidic system for fluid transfer to a microarray comprising:
at least one liquid transfer needle having a fluid conduit therein, a withholding pressure P1 being defined within the fluid conduit;
at least one microcompartment defined within the microarray, the microcompartment being configured to generate a capillary pressure P2 therein; and
wherein the capillary pressure P2 is less than the withholding pressure P1, such that a defined amount of liquid is transferred from the liquid transfer needle into the microcompartment when the liquid transfer needle and the microcompartment are disposed in fluid flow communication.

48. The microfluidic system as defined in claim 47, wherein the fluid conduit of said liquid transfer needle forms a capillary which generates said withholding pressure P1 by capillary effects.

49. The microfluidic system as defined in claim 47, wherein the capillary pressure P2 generated by the microcompartment acts in a direction substantially aligned with the liquid transfer needle.

50. The microfluidic system as defined in claim 47, wherein the microcompartment is approximately 50 to 150 micrometers (μm) in cross-sectional width.

51. The microfluidic system as defined in claim 50, wherein the microarray includes a plurality of said microcompartments spaced apart by distance at most equal to said cross-sectional width of each said microcompartment.

52. The microfluidic system as defined in claim 48, wherein the fluid conduit of said liquid transfer needle has a variable cross-section with at least two different dimensions.

53. The microfluidic system as defined in claim 52, wherein a first capillary pressure P3 is generated in a lower portion of the fluid conduit having a first dimension and a second capillary pressure P4 is generated in an upper portion of the fluid conduit having a second dimension, and wherein P3<P2<P4.

54. The microfluidic system as defined in claim 47, further comprising a pressure source in communication with the fluid conduit which generates the withholding pressure P1, and a pressure controller in communication between the pressure source and the liquid transfer needle, the pressure controller being operable to vary the withholding pressure P1 provided within the fluid conduit.

55. The microfluidic system as defined in claim 47, wherein an inner surface of the microcompartment is hydrophilic.

56. The microfluidic system as defined in claim 47, wherein an inner surface of the microcompartment is wettable to the liquid and an outer surface of the microcompartment is non-wettable to the liquid.

57. The microfluidic system as defined in claim 47, wherein the microarray includes a mask sheet sealed onto a substrate and defining at least one opening therein, the microcompartment being defined between an underside of the mask sheet and the opposing substrate, within said opening.

58. The microfluidic system as defined in claim 47, wherein the microcompartment is formed by reversibly sealing a thin sheet with an opening onto a solid support.

59. The microfluidic system as defined in claim 58, wherein at least one of the solid support and the thin sheet is coated with an adhesive layer to adhere the solid support and the thin sheet together.

60. The microfluidic microarray system as defined in claim 59, wherein the adhesive layer is made of PDMS.

61. The microfluidic system as defined in claim 59, wherein the adhesive layer defines at least one ring disposed such as to circumscribe the opening in the thin sheet.

62. The microfluidic system as defined in claim 61, wherein the ring is fixed one of reversibly and irreversibly on the solid support.

63. The microfluidic system as defined in claim 47, wherein the microcompartment is formed by reversibly sealing a thin sheet having rings that define wettability patterns, and wherein outer edges of the rings are non-wettable.

64. The microfluidic system as defined in claim 47, wherein the microcompartment is defined by a porous material, and wherein at least portions of the microarray surrounding the microcompartment are non-porous.

65. The microfluidic system as defined in claim 47, wherein the liquid transfer needle defines a tip having a cross-sectional area smaller than that of the micro compartment.

66. The microfluidic system as defined in claim 47, wherein the liquid transfer needle defines a tip having a cross-sectional area greater than that of the microcompartment.

67. The microfluidic system as defined in claim 66, wherein the tip of the liquid transfer needle is split into two spaced apart prongs by the fluid conduit extending therebetween.

68. The microfluidic system as defined in claim 66, wherein the tip of the liquid transfer needle includes two integrally formed prongs defining a channel therebetween, the channel providing said fluid conduit.

69. A slide for use in the microfluidic system of claim 47, the slide comprising microcompartments thereon which are arrayed and partitioned within larger macrocompartments.

70. A method of forming microfluidic microcompartments in a microarray comprising reversibly sealing a thin sheet having a plurality of openings therein onto a solid support substrate using an adhesive layer disposed between the thin sheet and the solid support substrate, the adhesive layer including rings which circumscribe each of the openings in the thin sheet to define the microcompartments therewithin.

71. A method for aligning components of a microfluidic system used for the preparation of microarrays for use in the multiplexed analysis of biomolecules, the method comprising: aligning an array of fluid transfer pins with a microfluidic mask sealed against a glass slide, by first aligning the mask to the glass slide, and then aligning the glass slide on a deck of a spotter which has been aligned relative to a spotting head having said array of fluid transfer pins, the spotting head being aligned relative to XY displacement axes of the spotter.

72. A method of delivering multiple solutions to a plurality of microcompartments in an microarray while avoiding cross-contamination between the solutions, the method comprising: contacting a first portion of an edge of the microcompartments with a first liquid solution; rinsing away the first liquid solution; and contacting a second portion of the edge of the microcompartments with a second liquid solution, the first and second portions of the edge of the microcompartments being different.

73. A method for delivering multiple solutions in parallel to an array of microcompartments, wherein a subset of the microcompartments are partitioned within macrocompartments, the method comprising: providing at least two fluid delivery pins per macrocompartment; arranging said pins within a spotting head in a configuration corresponding to that of said compartments; and spotting with at least two pins per macrocompartment to transfer multiple fluid solutions into different microcompartments of said macro compartments.

74. A method for multiplexing microarrays having a sandwich format and defining a plurality of microcompartments therein, the method comprising: individually delivering at least a first fluid solution containing a capture probe to each of the microcompartments; and individually delivering at least a second fluid solution to said each of the microcompartments using a cognate detection probe contained in said second fluid solution.
